(19) United States
(12) Patent Application Publication
(10) Pub. No.: US 2024/0381384 A1
(43) Pub. Date: Nov. 14, 2024

(54) Sidelink Collision Indicator UE Procedures

(71) Applicant: KONINKLIJKE PHILIPS N.V., EINDHOVEN (NL)

(72) Inventors: Sarun Selvanesan, Berlin (DE); Thomas Fehrenbach, Berlin (DE); Baris Goktepe, Berlin (DE); Thomas Wirth, Berlin (DE); Thomas Schierl, Berlin (DE); Cornelius Hellge, Berlin (DE)

(21) Appl. No.: 18/696,376

(22) PCT Filed: Sep. 5, 2022
(86) PCT No.: PCT/EP2022/074650

§ 371 Date: Mar. 28, 2024

(30) Foreign Application Priority Data
Sep. 30, 2021 (EP) 21200245.5

(51) Int. Cl. H04W 72/25; H04W 74/0808

(52) U.S. Cl. CPC H04W 72/25; H04W 74/0825

(57) ABSTRACT

A user device, UE, for a wireless communication system, is described. The UE is to transmit and/or receive over a sidelink, SL, in the wireless communication system. The UE is to receive one or more collision indications, Cis, the collision indication indicating one or more collisions on one or more resources used or to be used by the UE for one or more transmissions to or for one or more receptions from at least one further UE over the SL. Responsive to the collision indication and dependent on one or more criteria, the UE is to perform one or more certain actions for the one or more transmissions.

The present invention concerns the field of wireless communication systems or networks, more specifically the direct communication between user devices over a sidelink. Embodiments concern inter-UE coordination for improving a communication over the sidelink, e.g., for meeting an enhanced reliability and reduced latency requirements for a communication over the sidelink.

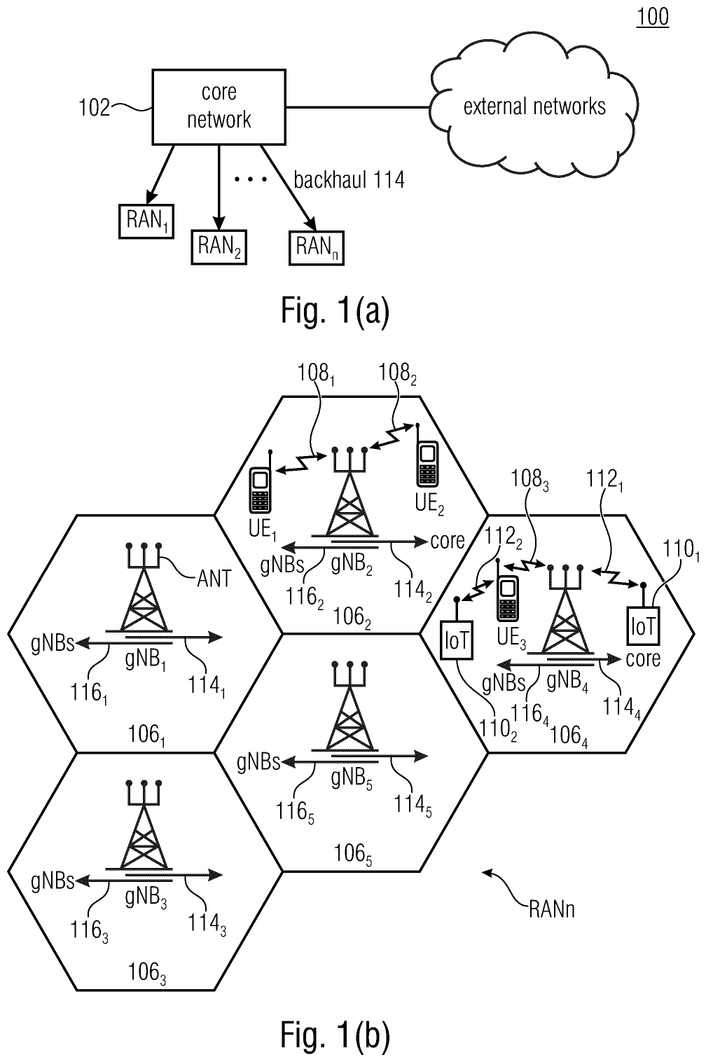

FIG. 1 is a schematic representation of an example of a terrestrial wireless network 100 including, as is shown in FIG. 1(a), the core network 102 and one or more radio access networks RAN₁, RAN₂, . . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2nd stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE, non-V2X 5G base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

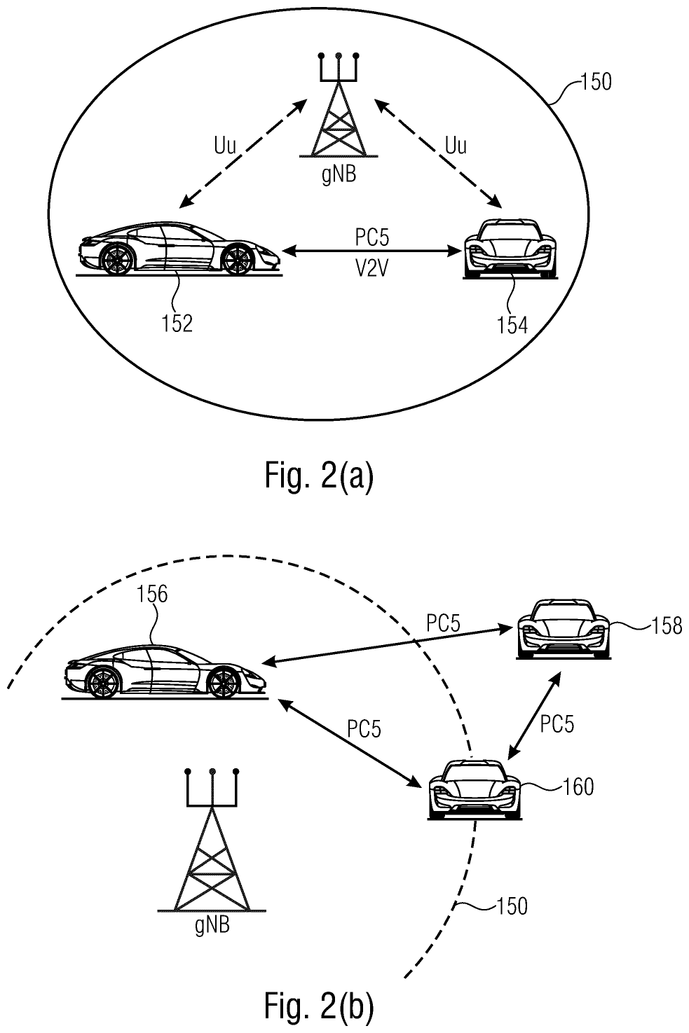

FIG. 2(a) is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface.

The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 2(b) is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2(b) which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2(a), in addition to the NR mode 1 or LTE mode 3 UEs 202, 204 also NR mode 2 or LTE mode 4 UEs 206, 208, 210 are present. In addition, FIG. 2(b), schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 2(a) and FIG. 2(b) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

In view of the above-described prior art, there may be a need for improvements of the communication over a sidelink in a wireless communication network between two user devices.

Embodiments of the present invention are now described in further detail with reference to the accompanying drawings:

FIG. 1 shows a schematic representation of an example of a wireless communication system;

FIG. 2(a) is a schematic representation of an in-coverage scenario in which two UEs directly communicating with each other are both connected to a base station;

FIG. 2(b) is a schematic representation of an out-of-coverage scenario in which the UEs directly communicate with each other;

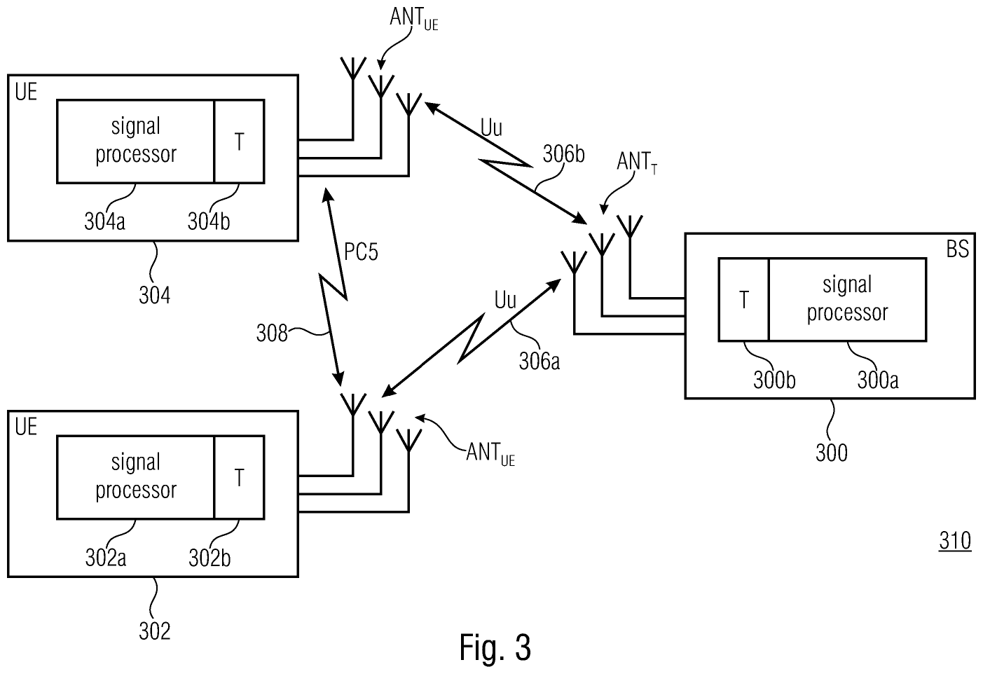

FIG. 3 is a schematic representation of a wireless communication system including a transmitter, like a base station, and one or more receivers, like user devices or UEs, capable of operating in accordance with embodiments of the present invention;

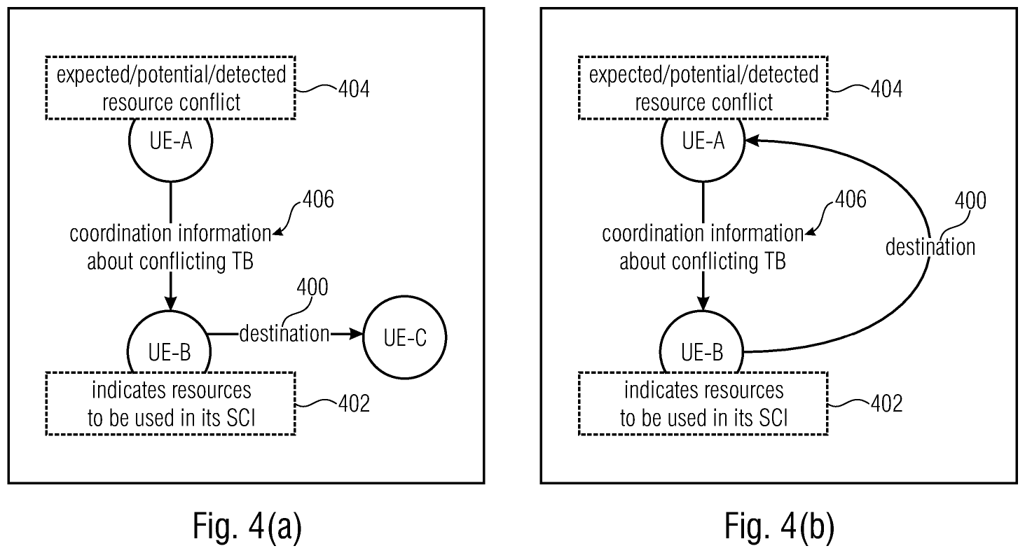

FIG. 4 illustrates examples for an inter-UE coordination for UEs operating in mode 2, wherein FIG. 4(a) illustrates a scenario in which the user device providing collision information and the user device being the destination of a transmission are different, and FIG. 4(b) illustrates a scenario in which the user device providing the collision indication is also the destination for the transmission;

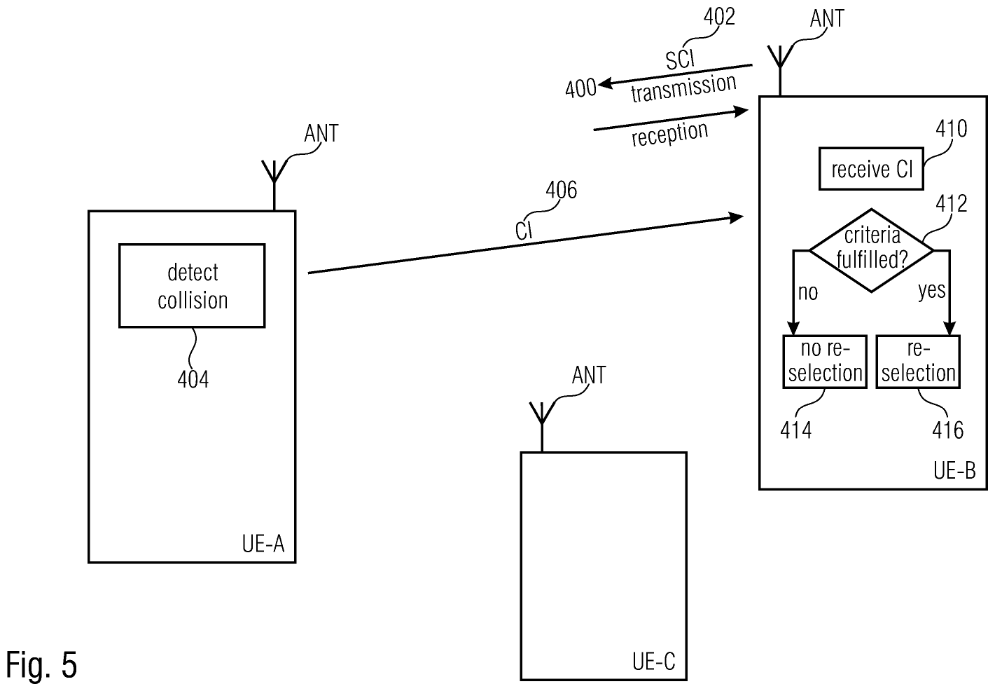

FIG. 5 illustrates an embodiment of the present invention; and

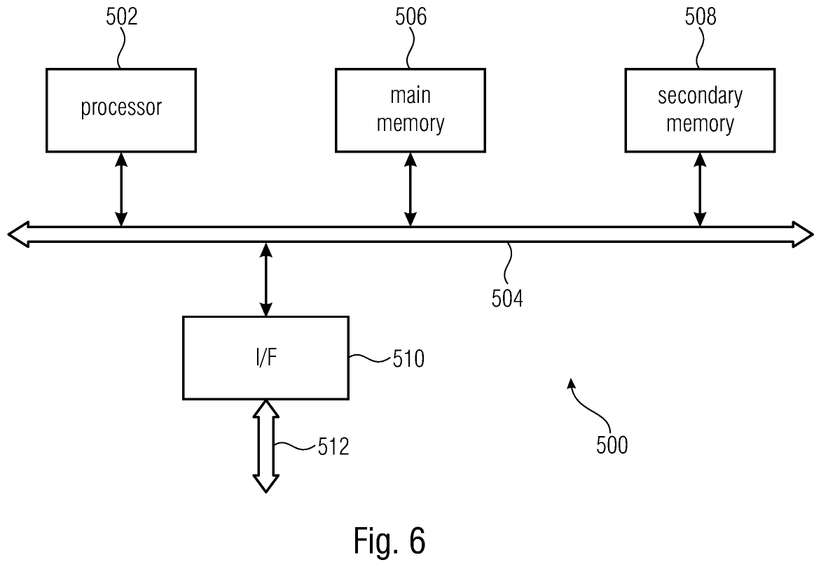

FIG. 6 illustrates an example of a computer system on which units or modules as well as the steps of the methods described in accordance with the inventive approach may execute.

Embodiments of the present invention are now described in more detail with reference to the accompanying drawings in which the same or similar elements have the same reference signs assigned.

For a wireless communication system or network as described above with reference to FIG. 1, FIG. 2(a) or FIG. 2(b), an initial vehicle-to-everything, V2X, specification was included in Rel. 14 of the 3GPP standard on the basis of the original device-to-device, D2D, communication standard with modifications regarding the scheduling and assignment according to the V2X requirements. Rel. 15 of the LTE V2X standards, also known as enhanced V2X or eV2X, was completed in 2018, and Rel. 16, the first release of 5G NR V2X, was completed in March 2020. The new release focuses on sidelink enhancements with an emphasis on power saving, enhanced reliability and reduced latency to cater not only vehicular communications but also public safety and commercial use cases. In order to meet enhanced reliability and reduced latency requirements, inter-UE coordination among UEs communicating over the sidelink may be employed. Inter-UE coordination is essentially assistance provided by to a user device, UE. The assistance may be in the form of an indication of a collision in the future or in the past, which triggers the transmitting UE to carry out a resource re-selection. There are two conventional schemes for the inter-UE coordination.

In accordance with inter-UE coordination scheme 1, an assistance information message, AIM, is sent from a first UE to a second UE which contains a set of preferred or not preferred resources, which the second UE may, in turn, use for its own transmissions, more specifically for selecting the resources for its own transmissions. The set of preferred or not preferred resources includes resources that are determined by the first UE to be available or unavailable for use by the second UE, and the AIM is a report including this information.

In accordance with inter-UE coordination scheme 2, an indication or coordination information is sent from the first UE to the second UE of a resource collision that occurred either in the past or may happen in the future. For example, the coordination information sent from the first UE to the second UE indicates the presence of an expected and/or a potential and/or a detected resource conflict on resources indicated by a SCI associated with a transmission by the second UE. In accordance with scheme 2, no resources sets are included in the indication that is sent to the second UE. However, the set of resources affected by the collision may be signaled implicitly, e.g., by the timing, resource index, phase shift, and/or frequency at which the indication is sent. The second UE is expected to trigger certain actions responsive to receiving the collision indication, e.g., a sensing and resource reselection procedure. For example, the indication informing the second UE about a resource collision is in the form on a non-acknowledgement, NACK, that is sent on the physical sidelink feedback channel, PSFCH, or on a channel provided for indications to be sent.

As mentioned above, in accordance with inter-UE coordination scheme 2, the second UE is expected to perform one or more certain actions, like a resource reselection. In other words, conventionally, when receiving a collision indication or the inter-UE coordination scheme 2 information, the second UE carries out or performs an action, like the sensing and resource reselection, which involves additional processing efforts at the second UE and, as a consequence, increases power consumption which, in turn, may drain the battery and shortens the operation time of the second UE before a charging of the battery is needed. However, even in case the second UE is configured or preconfigured to operate in accordance with the inter-UE coordination scheme 2, it may not always be desired that the UE, responsive to any collision indication, actually performs a certain action, like a resource reselection. When considering, as an example for the mentioned actions to be performed by the second UE, the sensing and resource selection procedure, in certain situations, like the ones indicated below, the additional efforts of performing a resource reselection may not be desired or needed.
For example, dependent on a priority associated with a transmission carried out by the second UE, in case the priority is below a certain threshold, like for a low-priority transmission, a non-successful transmission may be acceptable and in such a case a resource reselection may not be desired for avoiding unnecessary processing efforts at the second UE, thereby saving, e.g., energy.
In case higher layers enabled a data duplication and the data included in the transmission may be transmitted also over another resource, a resource reselection may not be desired, e.g., because the second UE knows that the transmission over the other resource, for which, e.g., no conflict is reported, is likely to be successful.
When the transmission is directed to a certain recipient or destination, it may not be necessary for the second UE to carry out or perform the resource reselection. This might be the case when the UE sees the transmission to the certain recipient or destination as not required, e.g., the destination is an RSU, which the UE might have already passed. The resource reselection may cause such a high delay that a transmission on reselected resources does not reach the said RSU. Instead, the data may be sent to another RSU, e.g., at a later point in time, without performing resource reselection. Another example: If the destination is a group, the UE might not see the need to perform resource reselection since it might not be required that all UEs within a group successfully receive this message but that only a certain number of UEs receive this message.
Dependent on a geographical position or zone or a speed at which the second UE moves or dependent on a geographical position or zone of the destination UE, a resource reselection procedure may not be desired. For example, in case the UE determines that it moves at a certain speed, a resource reselection may not be desired because at the time the resource reselection is completed, the second UE may be in an area where the resources indicated to be conflicting are actually no longer conflicting so that they may be used without the need to perform a resource reselection.
Dependent on the nature or kind of the information to be transmitted, a resource reselection procedure at the second UE may not be needed, for example, in case the information, like sensor data, is outdated not very frequently, i.e., remains stable or within certain boundaries within a certain time so that it is sufficient to transmit the information at a next opportunity, for example, at a next interval as defined by a certain periodicity.
When the second UE performs retransmissions for an initial transmission at a plurality of instances, in case a resource for one of the retransmission instances is indicated to be a conflicting resource, the second UE may not perform a resource reselection for the first retransmission instance as it may be sufficient for the retransmission to only use the second retransmission instance.
A resource reselection procedure at the second UE may also not be desired in case the collision information is received from certain sources or from certain areas.

Embodiments of the present invention address the above problems and provide, for example, improvements in the power saving properties of a UE operating in accordance with the inter-UE coordination scheme 2. In accordance with the present invention, a user device that transmits or receives over a sidelink in a wireless communication system may receive one or more collision indications which indicate one or more collisions on one or more resources used or to be used by the user device for one or more transmissions to or for one or more receptions from at least one further user device over the sidelink. Responsive to such a collision indication the UE performs one or more actions or operations or procedures dependent on one or more criteria. As a consequence, the UE does not automatically perform an operation or action, like a sensing and a resource reselection procedure, when receiving the collision indication, rather, it performs it only if it is determined that the one or more criteria are met, e.g., in one or more certain situations. Thus, embodiments of the present invention introduce a collision indicator, like a non-acknowledgement-like, NACK-like, collision indicator, that may be sent by a user device of the wireless communication network when detecting a past or a future resource collision related to a transmission to be performed by a transmitting UE, and the transmitting UE performs a certain action, like a sensing and resource reselection, responsive to receiving the collision indicator dependent on one or more criteria that need to be fulfilled.

The present invention is advantageous over conventional approaches as it allows a user device, like a user device transmitting/receiving over the sidelink and operating in mode 2, to perform a certain action, like a sensing and resource reselection procedure, only in case such a procedure is actually considered necessary at the UE. This limits the actual procedures to be carried out by a mode 2 UE to those considered necessary thereby saving processing power and, as a consequence, improving the power saving capabilities of the UE as by avoiding unnecessary or undesired procedures a substantial amount of power may be saved, thereby enhancing or prolonging the time a battery may power the user device before recharging is needed.

Embodiments of the present invention may be implemented in a wireless communication system as depicted in FIG. 1, FIG. 2(a) or FIG. 2(b) including base stations and users, like mobile terminals or IoT devices. FIG. 3 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 3, the one or more UEs 302, 304 of FIG. 3, and the base station 300 of FIG. 3 may operate in accordance with the inventive teachings described herein.

### User Device

The present invention provides a user device, UE, for a wireless communication system,
wherein the UE is to transmit and/or receive over a sidelink, SL, in the wireless communication system,
wherein the UE is to receive one or more collision indications, CIs, the collision indication indicating one or more collisions on one or more resources used or to be used by the UE for one or more transmissions to or for one or more receptions from at least one further UE over the SL, and
wherein, responsive to the collision indication and dependent on one or more criteria, the UE is to perform one or more certain actions for the one or more transmissions.

In accordance with embodiments, wherein the further UE comprises one or more of:
a destination UE to which the one or more transmissions are directed,
a source UE from which one or more receptions are received,
a coordinating UE, e.g., a scheduling UE or a group leader, GL, UE,
any other UE detecting the one or more collisions, e.g., detecting past or future collisions.

In accordance with embodiments, the one or more criteria comprise one or more of the following:
the one or more CIs indicate one or more collisions on one or more resources to be used by the UE, e.g., CIs related to one or more potential future collisions,
the one or more CIs indicate one or more collisions on one or more resources used by the UE, e.g., CIs related to one or more past collisions,
the one or more CIs indicate one or more collisions on one or more resources based on information from a control information, like Sidelink Control Information, SCI, associated with the one or more transmissions, e.g., based on a time resource indicator value, TRIV, or a frequency resource indicator value, FRIV, included in a SCI in case of retransmissions, or based on a resource reservation period included in a SCI in case of periodic transmissions,
a configuration or a preconfiguration for the UE, e.g., a BWP configuration or a resource pool configuration,
a number of CIs received,
a type of the UE, e.g., only a UE configured for an operation in a certain band, like a high band, is to perform an action,
a capability of the UE, e.g., only a UE having a certain number of transceivers or RF chains is to perform an action,
a HARQ status, e.g., a number of acknowledgements, ACKs, and/or of non-acknowledgements, NACKs, received for previous and/or ongoing transmissions, or an ACK/NACK ratio, or a number of not-received ACKs and/or NACKs in case one or more ACKs and/or NACKs were expected but not detected.

In accordance with embodiments, the UE is to receive the CI via one or more of the following:
a physical sidelink feedback channel, PSFCH, e.g., using a NACK or a NACK-like signal,
a PSFCH-like channel, e.g., using an ACK and/or a NACK or ACK-like signal and/or a NACK-like signal,
a dedicated Physical Collision Indicator Channel,
a first stage SCI or a second stage SCI,
an RRC signaling,
a Media Access Control-Control Element, MAC-CE.

In accordance with embodiments,
the one or more transmissions comprise a first transmission and one or more further transmissions, e.g., a first retransmission of the first transmission and a second retransmission of the first transmission,
the CI indicates a collision on one or more resources to be used by the UE for the one or more further transmissions, and
UE is to perform one or more of the following actions on receiving a collision indication:
carry out a resource reselection for only one of the further transmissions, e.g., only for a first one of the further transmissions or for another one of the further transmissions,
carry out a resource reselection for all the further transmissions, not carry out any resource reselection and perform the one or more further transmissions in the reserved resources,
not carry out any resource reselection and not perform the one or more further transmissions in the reserved resources,
increase a number of further transmissions configured for the data packet,
a change of a priority of the one or more further transmissions,
a further transmission on a different carrier, or in a different frequency band, or in a different resource pool or in a different bandwidth part,
wait for or trigger of a further UE or a base station to transmit assistance information, e.g., an AIM including information on a preferred or non-preferred set of resources to be used for the one or more further transmissions,
perform data duplication for the one or more further transmissions, like one or more further transmissions of a given transport block, TB, e.g. in the case that the transmission is of a high priority.

In accordance with embodiments, the criteria comprise on one or more of the following:
for which of the one or more further transmissions a collision is detected,
a priority of the first transmission or a retransmission,
whether data duplication is enabled in higher layers of the protocol stack,
a source of the received CI,
a geographical position or a zone or a speed/change of geographical position of the UE,
a geographical position or a zone of the destination UE,
a priority of a transmission on the one or more resources indicated in the CI,
a signal strength of the received CI,
a power threshold for the one or more transmission, the power threshold being adaptable based on the number of available resources.

In accordance with embodiments,
the one or more further transmissions comprises at least one retransmission of the first transmission, and
UE is to perform one or more of the following actions on receiving a collision indication:
   carry out a resource reselection for only a first retransmission,
   carry out a resource reselection for only a second retransmission,
   not carry out any resource reselection and perform the retransmission in the reserved resources,
   not carry out any resource reselection and not perform the retransmission in the reserved resources,
   increase a number of retransmissions configured for the data packet,
   perform a retransmission on a different carrier, or in a different frequency band, or in a different resource pool or in a different bandwidth part,
   wait for or trigger of a further UE or a base station to transmit assistance information, e.g., an AIM including information on a preferred or non-preferred set of resources to be used for the retransmission,
   perform data duplication for the retransmission, like a retransmission of a given transport block, TB, e.g. in the case that the transmission is of a high priority.

In accordance with embodiments, in case the resource reselection is to be performed dependent on the priority of the first transmission,
if the priority is below a threshold, like a low or medium priority, the UE is not to perform any reselection of resources for a collision detected on a resource for a first retransmission, to skip the first retransmission, and to perform a second retransmission, or
if the priority is below the threshold, the UE is to not to perform any retransmission, e.g., for reducing an interference to other UEs which might have an ongoing high priority transmission, or
if the priority is above the threshold, like a high priority, the UE is to perform the resource reselection only for the first one, some or all of the retransmissions.

In accordance with embodiments, in case the resource reselection is to be performed dependent on whether data duplication is enabled,
if data duplication is enabled, the UE is not to perform the resource reselection for the indicated collision, and, optionally, the UE is to not to perform the one or more further transmissions using the resources indicated in the CI.

In accordance with embodiments, in case the resource reselection is to be performed dependent on a source of the received CI, the UE is to perform one or more of the following:
a resource reselection only if the destination UE is the source of the received CI,
a resource reselection only if a GL UE is the source of the received CI,
a resource reselection if any UE is the source of the received CI.

In accordance with embodiments, in case the resource reselection is to be performed dependent on a geographical position or a zone or a speed/change of geographical position of the UE, e.g., a current geographical position or a zone or speed or relative position to the UE providing the CI or to the destination UE,
if the UE is not moving or is moving at a speed below a threshold, the UE is to perform the resource reselection, e.g., to avoid persistent collisions, and/or
if the UE is moving or is moving at a speed above the threshold, the UE is not to perform the resource reselection, e.g., because the UE may arrive at a location with non-conflicting resources for the future transmissions, and/or
if the UE is moving out of range of an entity that provided the CI, the UE is not to perform the resource reselection, e.g., when the CI was provided by an RSU pertaining to a given zone or geographical area, and the UE moves out of the said zone, the CI is not valid anymore,
if the UE is moving into a geographical area where the CI is not valid, the UE is not to perform the resource reselection, e.g., when the CI was provided by an RSU pertaining to a given zone or geographical area, and the UE moves out of the said zone, the CI is not valid anymore.

In accordance with embodiments, in case the resource reselection is to be performed dependent on a geographical position or a zone of the destination UE, the UE is to perform the resource reselection if one or more of the following criteria is met:
only if a distance between the UE and the UE providing the CI is below a configured or preconfigured distance, e.g., based on a minimum required communication range,
only if a distance between the UE and the destination UE is below a configured or preconfigured distance, e.g., based on a minimum required communication range,
only if both the UE providing the CI and destination UE are within the minimum required communication range.

In accordance with embodiments, in case the resource reselection is to be performed dependent on a priority of another transmission on the one or more resources indicated in the CI,
if a priority of the other transmission is higher than a priority of the one or more transmissions, the UE is to perform the resource reselection and is to perform the transmission using reselected resources, and
if the priority of the other transmission is lower than the priority of the one or more transmissions, the UE is not to perform the resource reselection and is to perform the transmission using the reserved resources.

In accordance with embodiments, in case the resource reselection is to be performed dependent on a measured signal strength of the received CI, the UE is to perform one or more of the following:
if a measured signal strength is higher than a configured or pre-configured threshold, the UE is to perform the resource reselection and is to perform the transmission using reselected resources, e.g., because the UE that transmitted the CI has detected a collision near to the UE,
if a measured signal strength is lower than a configured or pre-configured threshold, the UE is to not perform the resource reselection and is to perform the transmission using the reserved resources, e.g., because the CI indicates a collision on one or more resources used by another UE located at a certain distance from the UE so that a transmission of the other UE does not interfere with the intended transmission of the UE,
if a measured signal strength is lower than a configured or pre-configured threshold, the UE is to not perform the resource reselection and is not to perform the transmission using the reserved resources, e.g., because if the UE is performing a low priority transmission that may be skipped so as not to add interference to another UE performing a higher priority transmission.

In accordance with embodiments, the measured signal strength comprises one or more of the following:
a signal power, e.g., the Signal to Noise Ratio, SNR,
a Signal to Interference and Noise Ratio, SINR,
an interference power,
a Reference Signal Received Power, RSRP,
a Received Signal Strength Indicator, RSSI,
a Rank index, RI,
a power in a beam steered towards the UE, e.g., a power measured for a certain beam index.

In accordance with embodiments,
the UE is to repeatedly transmit certain information, e.g., sensor data,
the one or more transmissions comprises a plurality of transmissions of the certain information on one or more reserved resources,
the CI indicates a collision on one or more of the reserved resources to be used by the UE for the plurality of transmissions, and
UE is to perform one or more of the following actions on receiving a collision indication:
   carry out a resource reselection for a configured or pre-configured number of transmissions, after which the UE reverts back to the reserved resources, like one or more transmissions,
   carry out a resource reselection for a configured or pre-configured time duration, after which the UE reverts back to the reserved resources,
   not carry out a resource reselection and perform the one or more transmissions in the reserved resources,
   not carry out a resource reselection and not perform the one or more transmissions in the reserved resources,
   a change of a priority of the one or more transmissions,
   perform one or more of the plurality of transmissions on a different carrier, or in a different frequency band, or in a different resource pool or in a different bandwidth part,
   wait for or trigger of a further UE or a base station to transmit assistance information, e.g., an AIM including information on a preferred or non-preferred set of resources to be used for the plurality of transmissions.

In accordance with embodiments, the UE is to perform the action dependent on one or more of the following:
how quickly the certain information becomes outdated,
a periodicity indicated in a control message, like Sidelink Control Information, SCI, associated with an initial transmission of the certain information by the UE,
a priority of the plurality of transmissions,
whether data duplication is enabled in higher layers of the protocol stack,
a source of the received CI,
a geographical position or a speed/change of geographical position of the UE,
a geographical position of the destination UE.

In accordance with embodiments, the UE is to transmit the certain information with a certain periodicity.

In accordance with embodiments, in case the UE is to perform the resource reselection dependent on how quickly the certain information becomes outdated, on the periodicity and on the priority of the plurality of transmissions,
if a frequency with which the certain information becomes outdated is below a first threshold, the priority of the transmission is above a second threshold and the periodicity is above a third threshold, the UE is to perform the resource reselection, or
if a frequency with which the certain information becomes outdated is above the first threshold, the priority of the transmission is below the second threshold and the periodicity is below the third threshold, the UE is to perform one of the following:
   carry out a resource reselection due to other criteria, or
   not carry out a resource reselection and transmit in the original selected resources, or
   not carry out a resource reselection and drop the transmission, or
if a frequency with which the certain information becomes outdated is above the first threshold, the priority of the transmission is above the second threshold and the periodicity is below the third threshold, the UE is to perform the resource reselection, or
if a frequency with which the certain information becomes outdated is below the first threshold, the priority of the transmission is below the second threshold and the periodicity is above the third threshold, the UE is to perform one of the following:
   carry out a resource reselection, or
   carry out a resource reselection due to other criteria, or
   not carry out a resource reselection and transmit in the original selected resources.

In accordance with embodiments, in case the resource reselection is to be performed dependent on whether data duplication is enabled,
if data duplication is enabled, the UE is not to perform the resource reselection for the indicated collision, and, optionally, the UE is to refrain repeating the transmission using the resources indicated in the CI.

In accordance with embodiments, in case the resource reselection is to be performed dependent on a source of the received CI, the UE is to perform one or more of the following:
a resource reselection only if the destination UE is the source of the received CI,
a resource reselection only if a GL UE is the source of the received CI,
a resource reselection if any UE is the source of the received CI.

In accordance with embodiments, in case the resource reselection is to be performed dependent on a geographical position or a zone or a speed/change of geographical position of the UE, e.g., a current geographical position or speed or relative position to the UE providing the CI or to the destination UE,
if the UE is not moving or is moving at a speed below a threshold, the UE is to perform the resource reselection, e.g., to avoid persistent collisions, and
if the UE is moving or is moving at a speed above the threshold, the UE is not to perform the resource reselection, e.g., because the UE may arrive at a location with non-conflicting resources for the future transmissions,
if the UE is moving into a geographical area where the CI is not valid, the UE is not to perform the resource reselection, e.g. when the CI was provided by an RSU pertaining to a given zone or geographical area, and the UE moves out of the said zone, the CI is not valid anymore.

In accordance with embodiments, in case the resource reselection is to be performed dependent on a geographical position or zone of the destination UE, the UE is to perform the resource reselection
only if a distance between the UE and the UE providing the CI is below a configured or preconfigured distance, e.g., based on a minimum required communication range.
only if a distance between the UE and the destination UE is below a configured or preconfigured distance, e.g., based on a minimum required communication range,
only if both the UE providing the CI and destination UE are within the minimum required communication range.

In accordance with embodiments,
the one or more transmissions comprise a first transmission and one or more further transmissions, like periodic transmissions or one or more retransmissions of the first transmission, e.g., a first retransmission of the first transmission and a second retransmission of the first transmission, and
in case the CI indicates a collision on one or more resources used by the UE for the first transmission in the past, the UE is to perform one or more of the following:
   carry out a further transmission on one more future resources, without a resource reselection for the further transmission,
   carry out a further transmission on one more future resources and a resource reselection for the one or more resources indicated in the CI as well as for future reserved resources, e.g., for all future reserved resources or for future reserved resources up to a configured or preconfigured time duration or number of transmissions,
   not carry out any further transmission,
   increase a number of further transmissions configured for the data packet,
   a change of a priority of the one or more further transmissions,
   trigger higher layers of the protocol stack to increase or decrease a priority of the one or more further transmissions by the UE,
   a further transmission on a different carrier, or in a different frequency band, or in a different resource pool or in a different bandwidth part,
   wait for or trigger of a further UE or a base station to transmit assistance information, e.g., an AIM including information on a preferred or non-preferred set of resources to be used for the one or more further transmissions,
   perform data duplication for the one or more further transmissions, like one or more further transmissions of a given transport block, TB, e.g. in the case that the transmission is of a high priority.

In accordance with embodiments, the UE is to perform the one or more actions in case the UE is configured or preconfigured to support one or more certain actions, like a resource reselection, responsive to one or more CIs.

In accordance with embodiments, the UE is to perform the one or more actions dependent on one or more of the following indicated by a configuration or preconfiguration to support one or more certain actions, like a resource reselection. responsive to one or more CIs:
a type of CI,
a type of a UE providing the CI,
a priority of the one or more transmissions,
a geo-location or a zone of the UE,
a number of received CIs,
a cast type,
a configuration of a resource pool, e.g., whether a PSFCH is enabled or not,
a type of a resource pool, e.g., whether the resource pool is a transmit pool, a receive pool or an exceptional pool,
a configuration of a bandwidth part, BWP, e.g., a bandwidth of the BWP or a numerology of the BWP,
a frequency band in which the UE operates, e.g., a center frequency in a high band, like the mmWave band, or in a low band, like frequency range 1, FR1, or frequency range 2, FR2,
a Demodulation Reference Signal, DMRS, pattern,
a Modulation and Coding Scheme, MCS, e.g., a reselection procedure is to be performed only for a transmission using a MCS above a threshold, like a 64-QAM MCS,
a type of a destination UE for the transmission by the UE.

In accordance with embodiments, in case the configuration or preconfiguration indicates a type of CI, the UE is to perform the resource reselection
only when receiving a CI indicating one or more potential future collisions, or
only when receiving a CI indicating one or more past collisions, or
when receiving a CI indicating one or more potential future or past collisions.

In accordance with embodiments, in case the configuration or preconfiguration indicates a type of a UE providing the CI, the UE is to perform the resource reselection
only if the CI is from the destination UE for the one or more transmissions, or
if the CI is received from any UE that may or may not be the destination UE, like a GL-UE, or a relay, or a RSU, or a base station.

In accordance with embodiments, in case the configuration or preconfiguration indicates a priority of the one or more transmissions, the UE is to perform the resource reselection
only if the CI is associated with a transmission that is above a configured or preconfigured priority threshold.

In accordance with embodiments, in case the configuration or preconfiguration indicates a geo-location or a zone of the UE, the UE is to perform the resource reselection
only if a distance between the UE and the UE providing the CI is below a configured or preconfigured distance, e.g., based on a minimum required communication range
only if a distance between the UE and the destination UE is below a configured or preconfigured distance, e.g., based on a minimum required communication range,
only if both the UE providing the CI and destination UE are within the minimum required communication range.

In accordance with embodiments, in case the configuration or preconfiguration indicates a number of received CIs, the UE is to perform the resource reselection
only if the number of CIs associated to a particular resource is above a configured or preconfigured threshold.

In accordance with embodiments, in case the configuration or preconfiguration indicates a cast type, the UE is to perform the resource reselection
only for the indicated cast types, e.g., unicast, groupcast or broadcast.

In accordance with embodiments, the UE is to be configured or preconfigured using
Radio Resource Control, RRC, signaling along with a resource pool configuration or a BWP configuration,
Media Access Control, MAC, signaling,
Physical, PHY, layer signaling, e.g., first or second stage SCIs from another UE.

In accordance with embodiments,
the UE receives a plurality of CIs pertaining to different resources the UE reserved for future transmissions, and
the UE is to perform one or more of the following actions:
   carry out a resource reselection for all the indicated resources,
   trigger a further UE or a base station to transmit assistance information, e.g., an AIM including information on a preferred or non-preferred set of resources to be used for the one or more transmissions,
   pause or drop one or more retransmissions or further transmissions for a certain time duration or for all transmissions,
   in case the UE is configured or preconfigured with more than one transmit resource pool, change from a current resource pool to a new resource pool, and attempt to carry out the one or more retransmissions or further transmissions in the new resource pool,
   forward or relay the one or more retransmissions or further transmissions via another UE to the destination UE,
   adapt a power used for the transmission, e.g., power boost on the n future transmissions, with n being an integer.

In accordance with embodiments, the UE is to perform the one or more actions if a number of CIs is higher than an average number of expected collisions in a resource pool, e.g., based on a measured Channel Busy Ratio, CBR, of the resource pool

In accordance with embodiments,
the UE receives a plurality of CIs pertaining to resources used or to be used by the UE for a certain transmission, and
the UE is to
   consider all CIs and perform a resource reselection for all future resources associated with the certain transmission, or
   in case the UE is configured or preconfigured with more than one transmit resource pool, use for the certain transmission a resource pool that is different from a currently used resource pool.

In accordance with embodiments, in case the resource reselection is to be performed dependent on which of the one or more further transmissions a collision is detected, the UE is to carry out the resource reselection such that the one or more indicated colliding resources are excluded from the reselection procedure.

In accordance with embodiments, the UE is to perform the resource reselection for the one or more resources indicated in the CI and for one or more future reserved resources up to a pre-configured time duration or number of transmissions, and wherein, optionally, the UE is to return to an original periodicity after the pre-configured time duration or number of transmissions.

In accordance with embodiments, in case a transmission is skipped, the UE is to
use the skipped time slot for sensing in order to detect information about the source of the potential collision or any other interference source, and
adapt, using the information, a future sensing and resource selection procedure, e.g., in order to avoid future collisions.

In accordance with embodiments, the UE is to receive the CI from the destination UE or from at least one further network entity which is not the destination UE, e.g., from any further UE or from a radio access network entity, like a base station or RSU.

In accordance with embodiments, the one or more resources used or to be used by the UE comprise resources used by the UE in the past or resources reserved to be used by the UE in the future for the one or more transmissions to the destination UE.

In accordance with embodiments, the CI indicates one or a combination of following messages:
an ACK,
a NACK,
any collision,
a past resource collision
a future resource collision
a certain location of a resource collision.

In accordance with embodiments, the UE is operated in an out-of-coverage mode in which the UE
is not connected to a base station of the wireless communication system, e.g., the UE operates in Mode 2 or is not in an RRC connected state, so that the UE does not receive from the base station a sidelink resource allocation configuration or assistance, and/or
is connected to a base station of the wireless communication system, which, for one or more reasons, is not capable to provide a sidelink resource allocation configuration or assistance for the UE, and/or
is connected to a base station of the wireless communication system not supporting a sidelink service, like a NR V2X service, e.g., a GSM, UMTS or LTE base station.

In accordance with embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### System

The present invention provides a wireless communication system, comprising a plurality of the inventive user devices, UEs, configured for a sidelink communication using, for example resources from a set of sidelink resources of the wireless communication system.

In accordance with embodiments, the wireless communication system comprises one or more base stations, wherein the base station comprises one or more of a macro cell base station, or a small cell base station, or a central unit of a base station, or a distributed unit of a base station, or an Integrated Access and Backhaul, IAB, node, or a road side unit, RSU, or a UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Method

The present invention provides a method for operating a user device, UE, for a wireless communication system, the method comprising:
transmitting and/or receiving, by the UE, over a sidelink, SL, in the wireless communication system,
receiving, by the UE, one or more collision indications, CIs, the collision indication indicating one or more collisions on one or more resources used or to be used by the UE for one or more transmissions to or for one or more receptions from at least one further UE over the SL, and
responsive to the collision indication and dependent on one or more criteria, performing, by the UE, one or more certain actions for the one or more transmissions.

### Computer Program Product

Embodiments of the present invention provide a computer program product comprising instructions which, when the program is executed by a computer, causes the computer to carry out one or more methods in accordance with the present invention.

Embodiments of the present invention are now described in more detail. In the following description of embodiments of the present invention, a UE that transmits a collision indication, for example when detecting a collision, is referred to as UE-A. UE-A may or may not be an intended receiver of a transmission from a transmitting UE, referred to in the following as UE-B. In the latter case, the intended receiver of a transmission from UE-B is a further UE, referred to also as UE-C, and UE-A is not involved in the TX-RX pair including UE-B and UE-C. UE-B is also referred to as the transmitting or TX UE and receives the collision indication, in response to a transmission carried out or to be carried out by UE-B.

FIG. 4 illustrates examples for an inter-UE coordination for UEs operating in mode 2. FIG. 4(a) illustrates a scenario in which the user device providing collision information and the user device being the destination of a transmission are different, and FIG. 4(b) illustrates a scenario in which the user device providing the collision indication is also the destination for the transmission.

In FIG. 4(a), the transmitting UE, UE-B, performs a transmission to the destination UE, UE-C as is indicated at 400. The transmission is associated with a SCI, as is indicated at 402, by which UE-B indicates the resources used for the transmission. The wireless communication system provides, for example, one or more sidelink resource pools including resources to be used by the UEs for the sidelink communication, and on such resources UE-B also transmits the SCI. A further UE, UE-A, also receives the SCI when monitoring the respective resources and UE-A may determine, as is indicated at 404, an expected or potential or detected resource conflict regarding the resources indicated in the SCI of UE-B. UE-A may detect this, for example, because UE-A already knows about an ongoing or planned transmission on the resources which may be a transmission performed by UE-A or by another UE in the network. Responsive to the detection of a resource conflict, UE-A transmits coordination information or a collision indication, also referred to as CI, as is indicated at 406, to UE-B. The coordination information includes information about resources for which UE-A indicates a resource conflict, for example, the coordination information may include information about conflicting transport blocks, TBs. Thus, in the scenario of FIG. 4(a), UE-A may take a role of a coordinating or scheduling UE, without being the destination UE for the transmission of UE-B.

FIG. 4(b) illustrates a scenario in which UE-A takes the role of the coordinating or scheduling UE and is also the destination UE for the transmission of UE-B. In the same way as explained above with reference to FIG. 4(a), responsive to receiving the SCI from UE-B, UE-A may determine whether resource conflicts exist, as indicated at 404 and inform UE-B accordingly, as is indicated at 406.

Thus, in accordance with embodiments, UE-B may transmit to or receive from one or more of the following entities:
a destination UE to which the one or more transmissions are directed,
a source UE from which the one or more receptions are received,
a coordinating UE, e.g., a scheduling UE or group leader, GL, UE, like UE-A,
any other UE detecting the one or more collisions, e.g., detecting past or future collision.

In accordance with embodiments, UE-B is a mode 2 UE that
transmits a PSCCH or a PSSCH together with a SCI indicating one or more reserved resources to be used for its transmission,
receives the inter-UE coordination information from UE-A indicating one or more resource conflicts for the one or more reserved resources, and
in case certain criteria are fulfilled, performs, in accordance with the teachings of the present invention, one or more actions, like a resource reselection.

UE-A is the UE that detects the one or more resource conflicts on the one or more resources indicated in the SCI of UE-B, and that sends the inter-UE coordination information to UE-B. In other words, UE-A, as is indicated at 404, may detect a collision on resources used or reserved to be used by a transmission of UE-B. The transmission may be a transmission of a new packet that may be part of a periodic transmission, or it may be a new transmission, or it may be a retransmission of a transmission affected by a collision, e.g., a transmission not received due to the collision or canceled due to a collision detected on the associated resources. For example, the collision may occur because a transmission from UE-C on the SL radio channel is scheduled for the same resources used by UE-B. Also, the so-called half-duplex constraint may be considered a collision. In such a case, the collision is due to UE-A transmitting on the resource associated with the transmission from UE-B to UE-A. In that case, UE-A is not able to receive a reserved resource of UE-B because it is transmitting itself. Thus, when referring herein to a collision, this also covers the half duplex constraint.

In accordance with embodiments, UE-A detects a collision using one or more received control messages, like SCIs, for a transmission, e.g., a 1^{st} stage SCI and/or a 2^{nd} stage SCI associated with or for a transmission performed by the UEs transmitting on the SL, like UE-B or UE-C.

In accordance with embodiments, the CI 406 may be a conventional feedback message, like a conventional NACK. UE-A may transmit the CI 406 in the PSFCH, or in a collision indication channel that is separate from the PSFCH, or in a common message, e.g., in the PSSCH.

FIG. 5 illustrates an embodiment of the present invention, more specifically, a wireless communication system in which a plurality of UEs are provided that may transmit or receive over a sidelink radio channel. FIG. 5 illustrates three user devices, however, more or less user devices may be involved in a sidelink communication. The UEs may operate in mode 2 as explained above with reference to FIG. 2(b). In the embodiment illustrated in FIG. 5, UE-A is the UE providing the coordination information or collision indicator 406, as explained above with reference to FIG. 4, UE-B is a transmitting or receiving UE performing a transmission 400 accompanied by SCI 402 which is directed either to UE-A or to another UE, like UE-C, or receiving a transmission from another UE. UE-A, as explained above with reference to FIG. 4, detects a collision 404 and transmits the CI 406 that is received to UE-B, as is indicated at 410. Other than in prior art approaches, in accordance with which UE-B responsive to receiving the CI performs certain action, like a resource reselection procedure, in accordance with embodiments of the present invention, responsive to receiving the CI, it is determined whether the one or more criteria are fulfilled, as is indicated at 412, and in case the one or more criteria are not fulfilled, UE-B refrains from performing the action, like the reselection procedure, as is indicated at 414. Only in case the one or more criteria are fulfilled, UE-B actually performs action, like the reselection procedure, as is indicated at 416. This achieves the above-described advantages like the wiring for an improved power saving capability, as only for those situations in which a certain action, like a reselection procedure, is considered useful by UE-B, the actual processing and associated energy is invested, otherwise, no action or procedure is initiated thereby saving power.

In accordance with embodiments, the one or more criteria evaluated at 412 may be one or more of the following:
The one or more CIs relate to one or more potential future collisions, e.g., indicate one or more collisions on one or more resources to be used by UE-B.
The one or more CIs relate to one or more past collisions, e.g., indicate one or more collisions on one or more resources already used by UE-B.
The one or more CIs indicate one or more collisions on one or more resources used for one or more retransmissions of a first or initial transmission.
For example, a SCI associated with the initial or first transmission may include a time resource indicator value, TRIV, or a frequency resource indicator value, FRIV, indicating resources reserved by UE-B for its retransmission(s) within a certain number of future time slots or future sub-channels.
The one or more CIs indicate one or more collisions on one or more resources used for a repeated or periodic transmissions of information or a transport block, TB. For example, a SCI associated with the initial or first transmission may include a resource reservation period indicating the periodicity of resources to be used for the periodic transmissions,
A configuration or a preconfiguration for the UE, e.g., a BWP configuration or a resource pool configuration.
A number of CIs received,
A type of the UE.
For example, only a UE configured for an operation in a certain band, like a high band, e.g., operating in FR2, is to perform an action,
A capability of the UE.
For example, only a UE having a certain number of transceivers is to perform an action.
A Hybrid Acknowledge Request, HARQ, status.
For example, whether an action is performed may be decided dependent on a number of acknowledgements, ACKs, and/or of non-acknowledgements, NACKs, received for previous and/or ongoing transmissions, or dependent on an ACK/NACK ratio, or dependent on a number of not-received ACKs and/or NACKs in case one or more ACKs and/or NACKs were expected but not detected.
For example, if UE-B receives a CI for a TB that had already received a number of NACKs that are above a configured or preconfigured threshold, then UE-B has to reselect its resources. Otherwise, it may also switch resource pools/BWPs. UE-B determines that the NACKs are above a threshold by either using a configured or preconfigured threshold, or an ACK/NACK ratio received between the TX-RX UEs etc.
In another example, if UE-B receives a CI for a TB and has received a number of NACKs for one or more TBs within a certain time window from a single UE or multiple UEs that are above a threshold, then UE-B reselects its resources.

In accordance with embodiments, the CI is received as follows:
via a physical sidelink feedback channel, PSFCH, e.g., using a NACK or a NACK-like signal, or
via a PSFCH-like channel, e.g., using a ACK and/or a NACK or ACK-like signal and/or a NACK-like signal, or
via a dedicated Physical Collision Indicator Channel, e.g., a PCICH, or in a first stage SCI or a second stage SCI, or
via an RRC signaling, or
in a Media Access Control-Control Element, MAC-CE.

### Future Collisions

In accordance with embodiments, the one or more transmissions comprise a first or initial transmission and one or more further transmissions, e.g., a first retransmission of the first transmission and a second retransmission of the first transmission, and the CI indicates a future collision on one or more resources to be used by the UE for the further transmissions. UE-B may perform one or more of the following actions on receiving a collision indication:
Carry out a resource reselection for only a one of the further transmissions, e.g., only for a first one of the further transmissions or for another one of the further transmissions.
Not carry out any resource reselection and perform the one or more further transmissions in the reserved resources.
Not carry out any resource reselection and not perform the one or more further transmissions in the reserved resources.
Increase or decrease a number of further transmissions configured for the data packet.
Perform a further transmission on a different carrier, in a different frequency band, in a different resource pool or in a different bandwidth part.
Wait for or trigger a further UE or a base station to transmit assistance information, e.g., an AIM including information on a preferred or non-preferred set of resources to be used for the one or more further transmissions.
In accordance with embodiments, UE-B may wait until a timeout occurs and may then resume with one or more of the other actions listed above, or it may refrain from any further transmissions for this TB.
Perform data duplication for the one or more further transmissions of a given TB, e.g., in the case that the transmission is of a high priority.

The criteria for performing a certain action, like a sensing and resource reselection procedure, are one or more of the following:
For which of the one or more further transmissions a collision is detected.
A priority of the first transmission or a retransmission.
Whether data duplication is enabled in higher layers of the protocol stack.
A destination of the one or more further transmissions.
A geographical position or zone or a speed/change of geographical position of the UE.
A geographical position or zone of the destination UE.
A priority of a transmission on the one or more resources indicated in the CI.
A signal strength of the received CI.
For example, a UE may adapt its power for future transmissions. This may be dependent on a configuration, e.g., a power threshold, as well as on the number of available resources for the future transmission.
Its battery status, e.g., if the given UE is low on power, it might refrain from any resource reselection or it might perform resource reselection but reduce the amount of future transmissions or retransmissions in order to optimize its battery power.
A power threshold, the power threshold being adaptable based on an amount of available resources,
   In one example, in the case that the UE performs resource reselection and the resources selected are less than in previous transmissions, the UE may refrain from performing the transmission on the reselected resource since the power spectral density is not high enough, like below a pre-defined power threshold, and thus avoid an unsuccessful transmission on the given resources. The amount of resource required might be configured by this power threshold. On the contrary, if the power spectral density is high enough, the UE may transmit on the reselected resources.
   In another example, the UE may boost its power on the transmission on the reselected resources, in order to increase the power spectral density and thus the probability of a successful transmission.
   In another example, the UE may reduce its power on the transmission on reselected resource, if it wants to reduce interference to neighboring UEs, and avoid resource collisions with UEs which are out of a minimum required communication range of the given UE.
   In another example, the UE may use a power threshold for sensing to determine candidate resources for transmissions where the power threshold is adapted such that a certain ratio of the resources lies below the power threshold, hence are considered to be free. The same power threshold may be applied to the received CI, such that the CI is ignored if its received signal strength lies below the power threshold.

### Actions Selected Based on TRIV/FRIV

In accordance with embodiments, UE-B performs a first transmission, like an initial of first transmission of a TB or information and is configured or preconfigured to perform one or more retransmissions, e.g., in case the first transmission is not successfully received. UE-B may indicate in the SCI 402 associated with the first transmission a time resource indicator value, TRIV, or a frequency resource indicator value, FRIV, indicating resources reserved by UE-B for its one or more retransmissions within a certain number of future time slots or future sub-channels.

UE-A may detect and signal to UE-B a collision on resources to be used for a transmission by UE-B as well as by one or more other UEs. For example, using the SCI received from UE-B and one or more SCIs received from other UEs, UE-A determines, as is indicated at 404, whether the future reserved resources collide with a further SCI received from another UE or with a transmission to be performed by UE-A itself. UE-A sends the CI 406 to UE-B, thereby indicating a potential collision for the retransmissions to be performed for the same TB or information by UE-B. In accordance with embodiments, one or two retransmissions may be performed, however, in accordance with other embodiments, only one retransmission may be performed, or, in accordance with yet other embodiments, the number of retransmissions may be higher, for example, three or more retransmissions. In the following, embodiments are considered assuming that UE-B is configured to perform retransmissions at a first retransmission instance and at a second retransmission instance, i.e., is to perform two retransmissions. Nevertheless, the embodiments described below for two retransmissions, may also be applied to any pair of retransmissions performed in case there are more than two retransmissions configured, e.g., in case of three or more retransmissions.

In accordance with embodiments, UE-B may perform one or more of the following actions or procedures on receiving the CI 406 indicating a potential collision for the retransmissions:
Carry out a resource reselection for only a first retransmission.
Once the resource reselection is completed, UE-B uses the reselected resources for the first retransmission.
A second retransmission may be handled in one of the following ways:
   Perform the second retransmission as usual, e.g., on the resource that was already reserved to be used for the second retransmission,
   Perform the second retransmission on the same frequency resource used for the reselected retransmission of the first retransmission, (but on a different time resource, e.g., later in time),
   Perform resource reselection also for the second retransmission,
   Drop the second retransmission altogether, e.g., it might not be required since the first retransmission on the newly selected resources.
For example, this is done to overcome temporary collisions. Since this is transmitted on the sidelink and UEs are moving, the interference condition may change rapidly. Thus, the UE may revert to its original reservations after overcoming temporary collisions. The benefit is that this may reduce signaling, since the original resource reservation may be already known at the receiver of UE-Bs transmission.
Carry out a resource reselection for only a second or later retransmission.
The first retransmission may be carried out on the already selected resources, or the first retransmission may be dropped.
Not carry out any resource reselection and perform the one or more retransmissions in the reserved resources.
For example, this may be the case if the UE has a high priority transmission and is configured to ignore the CI, or in case it is the last retransmission and that the signaling overhead by doing resource reselection is weight higher then transmitting on a potential colliding resource. In this case, signaling may be reduced or wasting processing power for resource reselection may be avoided.
For example, this basically means that the UE ignores the CI that it receives. This may be done in case this is a high priority UE, which does not adhere to this configuration. Furthermore, the UE may use this information to signal to higher layer the interference condition, which may then take care of the interference situation by reconfiguring the UE, e.g., switching from Mode 2 to Mode 1, or changing the resource pool or BWP to a frequency band with less interference.
Not carry out any resource reselection and not perform the one or more retransmissions in the reserved resources.
For example, if the probability of a potential successful transmission is too low, due to the high usage of the given resource pool, the UE may refrain from any further retransmission on the reserved resources.
For example, this may be done if the resource pool is too crowded, e.g., too much interference, and the likelihood of a transmission is very low. Furthermore, this may be applied when the priority of a transmission is very low. The benefit is that the UE may reduce interference in this resource pool.
Increase a number of retransmissions configured for the data packet.
For example, there may be three possibilities:
   Perform reselection on a subset of the set of retransmissions
   Perform reselection on all retransmissions
   Perform no resource reselection, just increase the number of retransmissions for this TB
It is also possible to combine this with cases already described above, e.g., drop the retransmissions on the already selected resources, and just carry out retransmissions for the added retransmissions.
Perform a retransmission on a different carrier, in a different frequency band, in a different resource pool or in a different bandwidth part.
For example, in this case, it is most likely required to perform resource reselection in the new frequency band, since the resource utilization is different in another frequency band, meaning that the same time resources are not available on the new carrier. Since it is a different frequency band, the frequency resources must be reselected for any retransmission anyways. Once selected on the new carrier, it may be kept or it may be reselected for any new retransmission on this carrier.
Wait for or trigger a further UE or a base station to transmit assistance information, e.g., an AIM including information on a preferred or non-preferred set of resources to be used for the one or more retransmissions.
Once the information on a preferred or non-preferred set of resources is received, UE-B may carry out the first or the first and second retransmissions using the preferred resources. In accordance with embodiments, UE-B may until timeout a occurs and may then resume with one or more of the other actions listed above, or it may refrain from any retransmissions for this TB.
Perform data duplication for the retransmission of a given TB, e.g., in the case that the transmission is of a high priority. Since data duplication might be handled on a different layer of the protocol stack, the given UE might have to indicate to the higher layer, e.g., PDCP or MAC layer, that data duplication is to be performed for a given transmission.

In accordance with embodiments, UE-B may decide about the above-mentioned actions or procedures dependent on which one of the future retransmission instances the collision is detected. In other words, the question for UE-B to answer is basically whether it is able to manage a retransmission of an initially transmitted TB using only the remaining transmission instances for which no collision was detected or indicated. For example, if the initial transmission failed and the CI 406 indicates that a collision is detected on the resources to be used for the first retransmission, UE-B may only have one more retransmission instance to use for successfully transmitting the TB.

For example, in case the data transmission is delay constraint, it may not make sense to retransmit this at a later stage, e.g., sensor data from a sensor on the car might not be valid in a later time instance. On the other hand, if the data to be transmitted has a longer validity or a high priority, it may be required to use as many retransmission instances as possible.

### Actions Selected Based on Priority of the Transmission Made by UE-B

In accordance with further embodiments, UE-B may decide on performing/not performing a resource reselection procedure dependent on a priority of the transmission made by UE-B.

For example, using the 3GPP priority ranking extending from 1-8 with 1 being the highest and 8 being the lowest priority, a low priority may be assumed to have a 3GPP priority ranking of 7 and 8, a medium priority may be assumed to have a 3GPP priority ranking of 4-6 and a high priority may be assumed to have a 3GPP priority ranking of 1-3.

Again, it is assumed that UE-B is configured to perform two retransmissions of an initial transmission of a TB, and, as above, it is assumed that a collision is detected in the resources associated with the first retransmission. In such embodiments, if the priority is low or medium, for example is below a certain threshold, UE-B does not carry out any reselection of resources, skips the retransmission in the first retransmission instance for which the conflict has been indicated, and uses the remaining second retransmission instance for the retransmission of the initial TB. In accordance with other embodiments, in case the priority is low, UE-B may drop any retransmission, i.e., not perform a retransmission of the TB at any of the first and second retransmission instances for reducing an interference to one or more other UEs which may have an ongoing high priority transmission. In accordance with yet other embodiments, if the priority is high, for example above the threshold, UE-B may perform or carry out a resource reselection for the first retransmission only or for both the first and second retransmission instances.

For example, the collision might only be valid for the resource to be used for the first retransmission, in which case it makes sense to only perform resource reselection for the first retransmission. In case of a persistent collision on the retransmission resource, the UE may perform resource reselection for the two (or all) retransmissions.

### Actions Selected Based on Data Duplication

In accordance with further embodiments, UE-B may decide to perform/not perform a resource reselection procedure dependent on whether data duplication is enabled in the system, for example, by higher layers of the protocol stack. If data duplication is enabled, for example, for high priority transmissions, even in case one of the TB transmissions results in a CI 406, UE-B is aware that the duplicate transmission of the TB is most likely to be successful so that a resource reselection is actually not needed. In such a case, UE-B does not carry out or perform a resource reselection procedure for the resources indicated by the CI 406. In accordance with further embodiments, in such a scenario, UE-B may decide not to perform a retransmission using the resources for which the CI indicated a potential conflict, as it may be assumed that the duplicated message is transmitted on a non-conflicting resource. For this embodiment, since it might not be known at the physical layer (PHY) that data duplication is enabled at a higher layer, the UE-B may, once it receives a CI on the PHY, query its MAC or PDCP layer if data duplication is enabled for this transmission and dependent on the configuration act accordingly.

### Actions Selected Based on Destination of the Intended Retransmission

In accordance with yet further embodiments, UE-B may decide to perform/not perform a resource reselection procedure dependent on a destination of the intended retransmission. For example, a resource reselection is performed
only if the destination UE is the source of the received CI, or
only if a GL UE is the source of the received CI, or
if any UE is the source of the received CI.

### Actions Selected Based on Geographical Position of UE-B

In accordance with another embodiment, UE-B may determine to perform/not perform a resource reselection procedure dependent on its geographical position or zone or dependent on its speed or a change of its geographical position or zone. For example, UE-B may carry out the resource reselection dependent its current geographical location or speed or relative position to the coordinating UE, like UE-A, or dependent on its relative position to the destination UE, i.e., the recipient of UE-B's transmission. In case UE-B is not moving, for example is static, or is moving with the speed below a certain threshold, it may be assumed that the conflicting resources do not change, and UE-B performs a resource reselection in order to avoid persistent collisions. In case UE-B is not static or stationary but moves, for example, moves at a speed above the above-mentioned threshold, a resource reselection procedure may be skipped, i.e., not performed, because it is determined that UE-B is at a different location once the resource reselection procedure is completed at which the resources originally indicated to be conflicting, are no longer conflicting for the future transmissions to be carried out by UE-B.

In accordance with other embodiments, if UE-B is moving into a geographical area where the CI is not or no longer valid, UE-B does not perform the resource reselection. For example, when the CI was provided by an RSU pertaining to a given zone or geographical area, and when the UE moves out of this zone, the CI is not valid anymore. In other words, when the CI is detected by an RSU which is not mobile, the CI relevant only to the area or zone or geographical area around the RSU. If the UE moves out of this area, it may ignore the CI since it may be assumed that reuse of the original resource is possible without a collision.

### Actions Selected Based on Geographical Position of Destination UE

In accordance with even further embodiments, UE-B may determine to perform/not perform the resource reselection procedure dependent on a geographical position or zone of the destination UE, i.e., the recipient or intended recipient of the transmission. For example, UE-B may perform the resource reselection if one or more of the following criteria is met:
Only if a distance between UE-A and the UE providing the CI is below a configured or preconfigured distance, e.g., based on a minimum required communication range.
Only if a distance between UE-B and the target UE for this transmission or for the retransmission is below a configured or preconfigured distance, e.g., based on a minimum required communication range.
Both the UE providing the CI and target UE are within the minimum required communication range.

### Actions Selected Based on the Priority of a Transmission on the Conflicting

In accordance with another embodiment, UE-B may determine to perform/not perform a resource reselection procedure dependent on a priority of a transmission on the one or more resources indicated in the CI. For this, the UE-B may be preconfigured such that it will refrain from resource reselection for transmissions of TBs with a certain priority, w.r.t, the priority of its transmissions if it receives any CI or a CI from a particular UE or RSU, e.g., a coordinating UE. Furthermore, there may be different types of CIs which have a priority field attached to it. If this type of CI is received, UE-B may refrain to transmit any TB with lower priority when compared to the priority field attached to the given CI.

As mentioned above, the 3GPP priority ranking extending from 1-8 may be applied with 1 being the highest and 8 being the lowest priority. A low priority may be assumed to have a 3GPP priority ranking of 7 and 8, a medium priority may be assumed to have a 3GPP priority ranking of 4-6 and a high priority may be assumed to have a 3GPP priority ranking of 1-3. In accordance with embodiments, if a priority of the other transmission is higher than a priority of the one or more transmissions, UE-B performs the resource reselection and the transmission using reselected resources. This might be beneficial for the other UE performing the high priority transmission, which might not have received the CI, due to ongoing other transmissions or due to its geo position or due to the half-duplex constraint. Thus, UE-B may reduce potential interference to other UEs with high priority transmissions.

In accordance with other embodiments, if the priority of the other transmission is lower than the priority of the one or more transmissions, the UE does not to perform the resource reselection and performs the transmission using the reserved resources, e.g., because the low priority transmission by another UE is preempted by UE-B's high priority transmission.

In accordance with further embodiments, UE-B might read the CI 406 the same way as a preemption SCI. In such an embodiment, it is assumed that the CI, in addition to the conflicting resources, also indicates a priority of the transmission using the conflicting resources. In other words, in addition to the conflicting resources, the CI may also indicate a priority of the colliding traffic. In such an embodiment, UE-B may decide to perform a resource reselection procedure if the priority of the colliding traffic or the preempting packet, as indicated by the CI, is higher than the priority of the transmission to be performed by UE-B. Otherwise, in case the transmission to be performed by UE-B has a priority higher than the priority of the colliding traffic, UE-B does not perform a reselection procedure, but carries out the transmission on the initially scheduled resources.

### Actions Selected Based on Signal Strength of the Received CI

In accordance with another embodiment, UE-B may determine to perform/not perform a resource reselection procedure dependent on a signal strength of the received CI 406. For example, if the signal is weak the collision was detected further away, e.g., by a UE located at a distance to UE-B that is beyond a configured or preconfigured distance. The threshold may be set to determine when to take the CI into account. This threshold may also depend on transmission parameters such as a priority or a packet delay budget. For example, a low priority transmission may be skipped at a lower threshold so as to not add unnecessary interference to the system.

In accordance with embodiments, if a measured signal strength is higher than a configured or preconfigured threshold, UE-B may perform the resource reselection and the transmission using reselected resources. UE-B may apply this, for example, because UE-A that transmitted the CI has detected a collision near to the UE, like within a configured or preconfigured distance from UE-B. For example, in this case, the UE-B may combine the information included in the CI together with a power measurement, e.g., measuring interference power or SNR, and combine this information and thus trigger an action based on more information than just the information contained within the CI. In this way, UE-B has more than one indicator of a potential future collision and may thus take a better decision to assure a successful future transmission or retransmission.

In accordance with another embodiment, if a measured signal strength of the CI 406 is lower than the configured or preconfigured threshold, UE-B does not perform the resource reselection but performs the transmission using the reserved resources. UE-B make take this action, for example, because UE-A that transmitted the CI has detected a collision not near to the UE, like beyond the configured or preconfigured distance from UE-B, so that a transmission by another UE on the conflicting resources is considered to not interfere with the intended transmission of UE-B.

In accordance with yet another embodiment, if a measured signal strength of the CI 406 is lower than the configured or preconfigured threshold, UE-B does not perform the resource reselection and also does not to perform the transmission using the reserved resources. UE-B may apply this, for example, because a low priority transmission by UE-B may be skipped so as not to add interference to another UE performing a higher priority transmission.

In accordance with embodiments, the measured signal strength is identified by one or more of the following:
a signal power, e.g., the Signal to Noise Ratio, SNR,
a Signal to Interference and Noise Ratio, SINR,
an interference power,
a Reference Signal Received Power, RSRP,
a Rank index, RI,
a power in a beam steered towards the UE, e.g., a power measured for a certain beam index, e.g., measured by a beam index or sounding reference signal (SRS) of a particular beam.

### Actions Selected Based on Resource Reservation Period

In accordance with other embodiments of the present invention, UE-B may transmit certain information, e.g., sensor data, periodically or repeatedly. In other words, UE-B may perform a plurality of transmissions of the certain information on one or more reserved resources. UE-A may detect and signal to UE-B a collision on resources to be used for a transmission by UE-B as well as by one or more other UEs. For example, using the SCI received from UE-B and one or more SCIs received from other UEs, UE-A determines, as is indicated at 404, whether the periodic resources collide with a further SCI received from another UE or with a transmission to be performed by UE-A itself. UE-A sends the CI 406 to UE-B, thereby indicating a potential collision for the periodic transmissions to be performed of the same TB or information by UE-B.

In accordance with embodiments, UE-B may perform one or more of the following actions or procedures on receiving the CI 406 indicating a potential collision for reserved periodic resources:
Carry out a resource reselection for a configured or preconfigured plurality of transmissions, after which the UE reverts back to the reserved resources.
For example, this is done to overcome temporary collisions. Since this is transmitted on the sidelink and UEs are moving, the interference condition may change rapidly. Thus, the UE may revert to its original reservations after overcoming temporary collisions. The benefit is that this may reduce signaling, since the original resource reservation may be already known at the receiver of UE-Bs transmission.
Carry out a resource reselection for a configured or preconfigured time duration, after which the UE reverts to the reserved resources.
For example, this is done for the same reason as mentioned above, just that the number of transmissions in this embodiment is measured in time.
Not carry out a resource reselection and perform the one or more transmissions in the reserved resources.
For example, this may be the case if the UE has a high priority transmission and is configured to ignore the CI, or in case it is the last retransmission and that the signaling overhead by doing resource reselection is weight higher then transmitting on a potential colliding resource. In this case, signaling may be reduce or wasting processing power for resource reselection may be avoided.
Not carry out a resource reselection and not perform the one or more transmissions in the reserved resources.
For example, this may be done if the resource pool is too crowded, e.g., too much interference, and the likelihood of a transmission is very low. Furthermore, this may be applied when the priority of a transmission is very low. The benefit is that the UE may reduce interference in this resource pool.
Perform one or more of the plurality of transmissions on a different carrier, in a different frequency band, in a different resource pool or in a different bandwidth part.
Wait for or trigger a further UE or a base station to transmit assistance information, e.g., an AIM including information on a preferred or non-preferred set of resources to be used for the plurality of transmissions.
Once the information on a preferred or non-preferred set of resources is received, UE-B may carry out the period retransmissions using the preferred resources.

In accordance with embodiments, UE-B may decide on performing/not performing a resource reselection procedure in reply to such a CI dependent on the nature of the information to be transmitted, like the information contained in a TB to be transmitted. More specifically, UE-B may decide on performing the reselection procedure dependent on whether information to be transmitted becomes outdated quickly, for example whether it becomes outdated frequently or not. In accordance with other embodiments, UE-B may decide on performing/not performing the resource reselection procedure dependent on a periodicity as it may be indicated in the SCI associated with the transmission to be performed by UE-B, for example in the resource reservation period field, and/or dependent on a priority of the transmission.

For example, UE-B may decide on performing/not performing a resource reselection procedure dependent on whether a frequency with which the certain information becomes outdated is above/below a first threshold, whether the priority of the transmission is above/below a second threshold and whether the periodicity is above/below a third threshold. For example, the first threshold may be a configured or preconfigured time period threshold after which the information becomes outdated, the second may a configured or preconfigured priority threshold, and the third threshold may be a configured or preconfigured periodicity threshold.

For example, if the information does not get outdated frequently, if the transmission is a high priority transmission, and if the periodicity is high, for example above a certain threshold or belonging to a certain list, like the list sl-ResourceReservePeriod1-r16 ENUMERATED {ms0, ms100, ms200, ms300, ms400, ms500, ms600, ms700, ms800, ms900, ms1000}, UE-B may decide to carry out the resource reselection procedure for a resource for which a potential collision is indicated. For example, UE-B may apply this approach because its transmission is a high priority transmission of information that does not get outdated frequently, which is why UE-B uses longer periodicities. However, each of these periodic transmissions are important for the receiving UE and may negatively affect the transmitting UE if it were to miss the transmission from UE-B. Hence UE-B needs to carry out reselection to ensure that a non-colliding resource is selected for its transmission. In accordance with other embodiments, if the information gets outdated quickly, if the transmission is a low priority transmission and in case the periodicity is low, i.e. below a certain threshold or belonging to a certain list like sl-ResourceReservePeriod2-r16 in INTEGER (1 . . . 99), UE-B may not carry out a resource reselection procedure.

The following table indicates actions taken by UE-B depending on the priority, the frequency of information getting outdated and the periodicity in accordance with embodiments.

TABLE 1
Actions taken by UE-B

| | Frequency of | | |
|---|---|---|---|
| | information getting | | |
| Priority | outdated | Periodicity | Action taken by UE-B |
| High | High | Long | N/A, because TBs with information getting |
| | | | outdated quickly requires shorter periodicities. |
| High | High | Short | Resource reselection, because the UE needs to |
| | | | ensure it transmits each of the high priority |
| | | | periodic TBs. |
| High | Low | Long | Resource reselection, because the UE needs to |
| | | | ensure it transmits each of the high priority |
| | | | periodic TBs. |
| High | Low | Short | N/A, because TBs with information not getting |
| | | | outdated quickly may ideally require longer |
| | | | periodicities. |
| Low | High | Long | N/A, because TBs with information getting |
| | | | outdated quickly requires shorter periodicities. |
| Low | High | Short | UE-B may choose to |
| | | | Carry out resource reselection due to other |
| | | | criteria, or |
| | | | Not carry out resource reselection and transmit |
| | | | in the original selected resources and take a |
| | | | gamble that the RX UEs might be able to |
| | | | receive them, or not receive them but may |
| | | | manage if it skips this and receives the |
| | | | refreshed information in the next transmission, |
| | | | or |
| | | | Not carry out resource reselection and drop the |
| | | | transmission. |
| Low | Low | Long | UE-B may choose to |
| | | | Carry out resource reselection, or |
| | | | Carry out resource reselection due to other |
| | | | criteria, or |
| | | | Not carry out resource reselection and transmit |
| | | | in the original selected resources since it may |
| | | | not afford to not transmit since the information |
| | | | gets refreshed only after a longer period of time. |
| Low | Low | Short | N/A, because TBs with information not getting |
| | | | outdated quickly may ideally require longer |
| | | | periodicities. |

The information mentioned above may include, for example, sensor data, in case the UE is a sensor device providing certain measurements, like temperature or the like, that are to be transmitted repeatedly at regular (periodically) or irregular intervals to a receiver. In other words, these embodiments are not limited to a periodic transmission, but they are equally applicable to any repeated transmission of a certain information or TB differing intervals.

In accordance with further embodiments, UE-B may decide on performing/not performing a resource reselection procedure regarding the periodic transmissions also dependent on one or more criteria described in detail above, e.g., dependent on one or more of:
whether higher layers have data duplication enabled,
the destination of its intended retransmission,
a geographical position or zone or speed/change of geographical position of UE-B,
a geographical position or zone of the destination UE.

### Past Collisions

In accordance with other embodiments, UE-B may decide to perform the one or more actions, like the reselection procedure, in case a received CI relates to past collisions. For example, a CI relating to a past collision may indicate resources being in conflict either a retransmission or a periodic transmission by UE. In other words, the one or more transmissions made by UE-B may include a first or initial transmission and one or more further transmissions, like periodic transmissions or one or more retransmissions of the first transmission, e.g., a first retransmission of the first transmission and a second retransmission of the first transmission. In accordance with embodiments, UE-B may perform one or more of the following:
Carry out a further transmission on one more future resources, without a resource reselection for the further transmission.
For example, in case the resource indicated in the CI are different than the resource to be used for future transmissions by the given UE, the UE might decide not to perform resource reselection since it does not expect collisions on these resources. Furthermore, if the said UE may measure the utilization of the resource pool, and this is below a certain threshold, the given UE may expect other UEs to perform resource reselection and thus expect the chosen resource to be collision-free for its future transmission. The benefit is that it may thus reduce potential future collisions and/or reduce signaling overhead for signaling a new resource map in case it may have performed resource reselection.
Carry out a further transmission on one or more future resources and a resource reselection for the one or more resources indicated in the CI as well as for future reserved resources.
For example, for all future reserved resources or for future reserved resources up to a configured or preconfigured time duration or number of transmissions, UE-B may perform the resource reselection.
For example, this may be done in case the potential collisions are only expected to occur for a certain period. The benefit is that signaling may be reduced, since the resource reselection has to be performed only for a certain number of retransmissions after which the UE transmits on the resource already known to the receiver.
Not carry out any further transmission.
For example, the UE might decide that based on the CI it received in the past, that this resource pool is too full and might refrain from further transmissions in this resource pool. The benefit is that the interference will be reduced in this resource pool and that this may improve receptions for this UE.
Change the priority of the one or more further transmissions.
For example, this may be done to indirectly signal to other UEs to backoff from transmissions on the same resources, in case other UEs have transmissions with a lower priority. This information may be directly or indirectly deduced by CIs transmitted by a UE or RSU dependent on this particular further transmission in the future. The benefit is that the interference or potential collision for this transmission may be reduced.
Trigger higher layers of the protocol stack to increase or decrease a priority of the one or more further transmissions by the UE.
For example, this may be done in case the priority handling is done on a higher layer. The benefit is that the higher layer may perform a different level of reconfiguration of the PHY parameters for further transmissions. In this case, further transmissions may be performed with a higher success rate.

### Configurability

In accordance with further embodiments, UE-B may decide about performing the one or more actions, like performing a resource reselection procedure, dependent on whether UE-B is configured or preconfigured for supporting the handling of inter-UE coordination information or the CI. In case UE-B is configured or preconfigured, in accordance with embodiments, it may decide about the action(s) to be performed, like performing a resource reselection procedure, dependent on the criteria described above, and, in accordance with further embodiments, also or instead consider a type of the configuration or preconfiguration.

In other words, in accordance with embodiments, once UE-B is configured or preconfigured to support the inter-UE coordination scheme 2, it may perform the one or more actions dependent on one or more of the following indicated by the configuration or the preconfiguration:
a type of CI,
a type of a UE providing the CI,
a priority of the one or more transmissions,
a geo-location or zone of the UE,
a number of received CIs,
a cast type,
a configuration of a resource pool, e.g., whether a PSFCH is enabled or not,
a type of a resource pool, e.g., whether the resource pool is a transmit pool, a receive pool or an exceptional pool,
a configuration of a bandwidth part, BWP, e.g., a bandwidth of the BWP or a numerology of the BWP,
a frequency band in which the UE operates, e.g., a center frequency in a high band, like the mmWave band, or in a low band, like frequency range 1, FR1, or frequency range 2, FR2,
a Demodulation Reference Signal, DMRS, pattern,
a Modulation and Coding Scheme, MCS, e.g., a reselection procedure is to be performed only for a transmission using a MCS above a threshold, like 64-QAM MCS,
a type of a destination UE for the transmission by the UE.

In accordance with embodiments, when deciding dependent on a type of the CI, UE-B may perform a resource reselection procedure only in case it receives a CI that indicates potential future collision, or only in case it receives a CI indicating a past collision, or in case the CI received indicates potential future collisions and/or past collisions. In accordance with this embodiment, the following benefits may be achieved:
CI that indicates potential future collision: There may be other UE which may transmit information which is relevant only at the time transmitted, e.g., traffic updates, traffic lights, video footage, etc. Hence, these UE are only interested in avoiding future collisions. Past collisions result in packet losses which are not relevant to the use case as the information is already obsolete.
CI indicating a past collision: There may be UEs with low processing capabilities or communicating over large distances where it is not possible for them to receive future collision indications. Hence, they may rely on past indications. Another class of UEs may be sensors which wake-up for a short time, perform a burst transmission and then go back to sleep. These may not require to receive future CIs but only past CIs.
Both: Any other UE may profit from more information, as it may adapt its future transmissions as well as issue retransmissions by considering past collisions.

In accordance with embodiments in which UE-B decides dependent on the type of UE sending the CI, i.e. the type of UE-A, UE-A may perform the resource reselection procedure only if the CI is transmitted from the destination UE, i.e. from the intended recipient UE for the transmission performed by UE-B. In the above embodiments, this means that UE-B performs the resource reselection procedure only in case the destination UE and the coordinating UE are the same, as described above as referenced to FIG. 4(b). One advantage for this is that it may reduce the signaling overhead for configuring resource reselection since the UE may be preconfigured to just perform resource reselection when receiving a CI from its intended recipient. Furthermore, this may limit the cases of UEs performing resource reselection in total. In case all UEs start performing resource reselection for the same TB, this might cause collisions on other resources.

In accordance with other embodiments, UE-B may perform a certain action, like the resource reselection procedure, if a CI is received, either from the destination UE or from any other UE, like a GL-UE, or a relay, or a RSU. For example, a coordinating UE like a GL-UE or a relay or a RSU may have a more information available on the interference situation in at certain geographical area or zone as compared to another UE traveling through the same area. For an RSU, this might be the case since the RSU is typically fixed installed along a route. Thus, a CI received from such a node may trigger a different behavior in a UE then a CI received from another UE.

When deciding about a certain action, like the performing/not performing a resource reselection procedure, dependent on a priority of a transmission, UE-B may decide to perform the action only in case the CI is associated with a transmission that is above a configured or preconfigured priority threshold, i.e., a priority threshold included in the configuration or preconfiguration at UE-B.

When deciding about a certain action, like the resource reselection procedure, dependent on a geolocation or zone of the UE providing the CI, like UE-A, UE-B may perform a resource reselection procedure only if the CI is received from a UE that is located at a distance from UE-B which is below a configured or preconfigured distance, wherein the distance may be based on the minimum required communication range. In accordance with such embodiments, UE-B disregards any CIs that are received from UEs being located beyond the configured or preconfigured distance as it is assumed that a transmission of UE-B and a transmission of this further UE are not likely to collide or cause a substantial interference so that for collisions indicated by such UEs the UE refrains from performing the resource reselection procedure.

In accordance with further embodiments, in case the UE decides about a certain action, like the resource reselection procedure, dependent on a number of received CIs, UE-B may perform a reselection procedure only in case a predefined number of CIs is received for a particular resource, for example in case a number of CIs associated with a particular resource is above a configured or preconfigured threshold. For example, this may be done to assure that a resource reselection is really required, e.g., to identify persistent collisions on a given resource.

When deciding about a certain action, like the performing/not performing a resource reselection procedure, dependent on a cast type, the UE is to perform the resource reselection only for the indicated cast types, e.g., a unicast, a groupcast or a broadcast. For example, this may allow a prioritization of a certain cast type in a given resource pool or this may help to avoid persistent collisions for a certain case type, e.g., if the UE is configured to always perform resource reselection for unicast but not for groupcast. Also, this may reduce signaling, since recipient UEs of groupcast messages do not have to be informed about reselected resources if resource reselection is limited to unicast.

In the above-described embodiments, the respective types may be associated with a Boolean flag, for example in the configuration or reconfiguration the flag may be toggled to indicate whether UE-B is to support the particular action or not.

In accordance with embodiments, the above-mentioned configurations may be provided to the UE in one or more of the following ways:
Using a Radio Resource Control, RRC, signaling along with a resource pool configuration or a BWP configuration.
Using a Media Access Control, MAC, signaling.
Using a Physical, PHY, layer signaling, e.g., first or second stage SCIs from another UE.

The configuration or preconfiguration may indicate whether UE-A may transmit a CI that indicates either only future potential collision and only a past collision, and whether UE-B may determine the nature of the CI based on the configuration or the configuration of the resource pool. For example, this allows a configuration of CIs on different levels: In case the configuration is resource pool-based, the signaling overhead for CI information in a resource pool may be reduced since individual CI configurations are not done. Furthermore, a UE may decide based on different factors, e.g., reliability requirements, whether to choose a resource pool which has CIs enabled or whether this is not required for a given service type.

### Receiving Multiple CIs

In accordance with embodiments, UE-B may receive multiple CIs pertaining to different resources UE-B has reserved for future transmissions. For example, the multiple CIs may include two or more CIs received from the same or from different UEs in the vicinity of UE-B. In such a case, receiving the multiple CIs pertaining to different resources may indicate to UE-B that there is a large amount of interference coming from UEs that may be beyond its sensing range and, hence, the sensing procedure applied by UE-B may not be able to detect or pick up such conflicts.

In a scenario in which UE-B receives multiple CIs pertaining to different resources UE-B reserved for future transmissions, UE-B may perform one or more of the following actions:
Carry out a resource reservation for all the indicated resources.
Trigger a further UE or a base station to transmit assistance information, e.g., an AIM including information on a preferred or non-preferred set of resources to be used for the one or more transmissions.
Pause or drop one or more retransmissions for a certain time duration or for all transmissions.
In case the UE is configured or preconfigured with more than one transmit resource pool, change from a current resource pool to a new resource pool, and attempt to carry out the one or more transmissions in the new resource pool.
Forward or relay the one or more transmissions via another UE to the destination UE.
Adapt a power used for the transmission, e.g., power boost on the n future transmissions, with n being an integer.

In accordance with embodiments, UE-B may perform the one or more actions if a number of CIs is higher than an average number of expected collisions in a resource pool, e.g., based on a measured Channel Busy Ration, CBR, of the resource pool. For example, if multiple CIs are detected for the same resource reservation period, either due to multiple past collision indications or due to a combination of past and future collision indications, UE-B performs a resource reselection. The threshold to perform the resource reselection may depend on and may be higher than an average expected number of collisions in the current resource pool. This may be estimated for example by using the CBR of the pool. For example, a high CBR indicates that resource usage in the given resource pool is high and thus the likelihood of collisions is higher than in a resource pool with a lower CBR. Thus, a given UE may combine information from CIs as well as the current CBR on its decision whether to continue transmission in a particular resource pool or whether the reliability of its transmissions is higher when switching to another resource pool, e.g., switching to another transmit resource pool or to an exceptional pool.

In accordance with further embodiments, a UE-B may suspend, for example pause or drop, retransmissions for a certain time duration or for all transmissions. In accordance with other embodiments, in case the network is configured with more than one sidelink resource pool, like more than one transmit resource pool for the sidelink communication, UE-B may change from a currently used resource pool to another resource pool and carry out its transmissions using resources from the other resource pool. In accordance with yet other embodiments, a UE-B, in such a situation, may forward or relay the transmission to another UE, for example to a UE different from UE-A for having it transmitted to the intended destination UE.

In accordance with yet other embodiments, UE-B may receive multiple CIs pertaining to the same resource UE-B intends to use for a transmission of TB, and the CIs may indicate a potential collision in the future or in the past. In such a scenario, a UE-B may take into consideration the received CIs and carry out a resource reselection procedure for the future resources associated with a given transmission. In accordance with other embodiments, the UE may also switch to another resource pool, in a similar way as described above.

In accordance with further embodiments, when a plurality of CIs are obtained by the coordinating UE, like UE-A (see FIG. 4), they may be merged into an assistance information message that is transmitted by UE-A to UE-B.

CI Including a Resource on which UE-B Receives

In accordance with the embodiments described so far, UE-B receives one or more CIs that indicate one or more collisions on one or more resources used or to be used by the UE for one or more transmissions. However, the present invention is not limited to such embodiments. In accordance with further embodiments, UE-B may receive one or more CIs that indicate one or more collisions on one or more resources used or to be used by the UE for one or more receptions from at least one further UE over the SL, and dependent on one or more criteria, UE-B may perform one or more certain actions, like those described in detail in the preceding embodiments.

For example, in the case UE-B receives a CI for a future reception, it may send an AIM and/or a CI to the TX UE in order to have the TX UE reselect its resources used for the transmission to UE-B. The AIM may contain a set of preferred or non-preferred resources to be used for the transmission from the TX UE to UE-B.

### General

Embodiments have been described in accordance with which the CI is received from another UE. However, the present invention is not limited to such embodiments. In accordance with further embodiments, UE-B may receive the CI from any further network entity, e.g., from a radio access network entity, like a base station or an RSU. For example, an RSU may indicate to UEs coming into its zone that certain collisions are currently about to happen. The UE may then already exclude these resources or move to a different resource pool.

Embodiments have been described with reference to a resource reservation procedure as an example for the one or more actions UE-B may perform dependent on the one or more criteria. However, the present invention is not limited to this action, rather the one or more actions may include one of more of the following:
Power adaptation, e.g., transmit power may be increased or decreased for future transmissions or retransmissions responsive to receiving a CI.
HARQ handling: e.g., in this case, a past CI may be treated as a NACK, which are not counted as retransmissions. Hence, more retransmissions are performed in total for a given TB,
MCS adaption: the MCS-level may be changed responsive to receiving a CI, by this, the code rate is decreased in order to counter collisions in the past and/or potential future collisions.

Embodiments have been described which indicate different criteria on the basis of which UE-B decides to perform or not perform an action, like a resource reservation procedure. It is noted that the above-mentioned embodiments may be used individually by a certain UE-B, or some or all of the embodiments may be combined.

In accordance with embodiments, UE-B may carry out or perform the resource reselection procedure for the resources indicated in the CI collision, and, in case UE-B also reserved resources for future transmissions, UE-B may carry out the resource reselection procedure for some or all of the future reserved resource, for example up to a preconfigured time duration or up to a preconfigured number of transmissions. In accordance with embodiments, following this process, UE-B may revert back to the original periodicity. Thus, resource reselection based on CIs may be only an automatic procedure, which is chosen in order to overcome temporary persistent collisions. Thus, signaling traffic may be spared in case UE-B continues using its original periodicity afterwards.

In accordance with embodiments, in case UE-B decides to not perform a certain transmission, like to skip a retransmission, UE-B may use the skipped time slot for sensing or determining a source of the potential collision or any other interference source. This information may be used by UE-B to adapt its future sensing and resource selection procedure thereby improving the chances to avoid future collisions. For example, in case a priority transmission is detected, future instances of colliding transmissions may be skipped and a resource reselection procedure is triggered by UE-B. In accordance with other embodiments, in case a dynamic one-shot transmission is detected, no action is required by UE-B.

Details of the above-mentioned AIMs are described, e.g., in the following European patent applications, the contents of which is incorporated herein by reference:
EP 20164706.2, “NR SIDELINK ASSISTANCE INFORMATION MESSAGES”, filed on Mar. 20, 2020
EP 20197035.7, “TIMING ASPECTS FOR NR SL ASSISTANCE INFORMATION MESSAGES”, filed on Sep. 18, 2020
EP 20203155.5, “NR SIDELLINK ASSISTANCE INFORMATION MESSAGES PROCEDURES”, filed on Oct. 21, 2020
EP 21173155.9, “SIDELINK INTER-UE COORDINATION PROCEDURES”, filed on May 10, 2021

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 6 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory, RAM, and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

The above-described embodiments are merely illustrative for the principles of the present invention. It is understood that modifications and variations of the arrangements and the details described herein are apparent to others skilled in the art. It is the intent, therefore, to be limited only by the scope of the impending patent claims and not by the specific details presented by way of description and explanation of the embodiments herein.

1. A user device comprising:
a processor circuit and a memory circuit, wherein the memory is arranged to store instructions for the processor circuit,
wherein the processor circuit is arranged to is to transmit and/or receive over a sidelink,
wherein the processor circuit is arranged to is to receive at least one collision indications
wherein the at least one collision indications indicate at least one collisions on at least one resources,
wherein the at least one resources are used or the at least one resource are arranged for use by the user device for at least one transmissions or for at least one receptions from at least one second user device over the sidelink
wherein the processor circuit is arranged to is to perform at least one actions for the at least one transmissions is response to the collision indication and base on at least one criteria.

2. The user device, user device of claim 1, wherein the second user device is selected from the group consisting of a destination user device, wherein at least one transmissions are directed to the second user device, a source user device, wherein at least one receptions are received by the second user device, a coordinating user device, and a detection user device, wherein the detection user device detects the at least one collisions.

3. The user device of claim 1, UE, of claim 1, wherein the at least one criteria is selected from the group consisting of the at least one collision indications indicate at least one collisions on at least one resources, the at least one collision indications indicate at least one collisions on at least one resources used by the user device, the at least one collision indications indicate at least one collisions on at least one resources based on information from a control information associated with the at least one transmissions or based on a resource reservation period included in a Sidelink Control Information of periodic transmissions, a configuration or a preconfiguration for the user device, a number of collision indications received, a type of the user device a capability of the user device and a HARQ status.

4. The user device of claim 1, wherein the user device receives the at least one collision indications via at least one of a physical sidelink feedback channel, a dedicated Physical Collision Indicator Channel, a first stage Sidelink Control Information or a second stage Sidelink Control Information, an RRC signaling, and a Media Access Control-Control Element.

5. The user device of claim 1,
wherein the at least one transmissions comprise a first transmission and at least one second transmissions,
wherein the at least one collision indications indicates a collision on at least one resources allocated for use by the user device for the at least one second transmissions,
wherein processor circuit is arranged to perform at least one of a resource reselection for only one of the second transmissions upon receiving a collision indication, a resource reselection for all the second transmissions upon receiving a collision indication, refraining from resource reselection and perform the at least one second transmissions in the reserved resources upon receiving a collision indication, refraining from resource reselection and not perform the at least one second transmissions in the reserved resources, increase a number of second transmissions configured for the data packet, a change of a priority of the at least one second transmissions, a second transmission on a different carrier, or in a different frequency band, or in a different resource pool or in a different bandwidth part, wait for or trigger of a second user device or a base station to transmit assistance information, perform data duplication for the at least one second transmissions.

6. The user device of claim 1, wherein the criteria comprise on at least one of detection of a collision in the at least one second transmissions, a priority of the first transmission or a retransmission, whether data duplication is enabled in higher layers of the protocol stack, a source of the at least one collision indications, a geographical position or a zone or a speed/change of geographical position of the user device a geographical position or a zone of the destination user device a priority of a transmission on the at least one resources indicated in the at least one collision indications, a signal strength of the at least one collision indications, a power threshold for the at least one transmission, the power threshold being adaptable based on the number of available resources.

7. The user device of claim 5,
wherein the at least one second transmissions comprises at least one retransmission of the first transmission,
wherein processor circuit is arranged is to perform at least one of resource reselection for only a first retransmission on receiving a collision indication, a resource reselection for only a second retransmission on receiving a collision indication, refrain from resource reselection and perform the retransmission in the reserved resources on receiving a collision indication, refrain from resource reselection and not perform the retransmission in the reserved resources on receiving a collision indication, increase a number of retransmissions configured for the data packet on receiving a collision indication, perform a retransmission on a different carrier, or in a different frequency band, or in a different resource pool or in a different bandwidth part on receiving a collision indication, wait for or trigger of a second user device or a base station to transmit assistance information on receiving a collision indication, duplicate data for the retransmission on receiving a collision indication.

8. The user device of claim 7,
wherein the processor circuit is arranged to perform the resource reselection based on the priority of the first transmission
if the priority is below a threshold the processor circuit is arranged to is not to perform any reselection of resources for a collision detected on a resource for a first retransmission and to perform a second retransmission, and/or
if the priority is below the threshold, the processor circuit is arranged to is to not to perform any retransmission, and/or
if the priority is above the threshold the processor circuit is arranged to perform the resource reselection only for at least one of the retransmissions.

9. The user device of claim 5,
wherein the processor circuit is arranged to perform the resource reselection based on whether data duplication is enabled
if data duplication is enabled the processor circuit is arranged to is not to perform the resource reselection for the indicated collision.

10. The user device of claim 5,
wherein the processor circuit is arranged to perform the resource reselection based the at least one collision indications,
wherein the processor circuit is arranged to perform the resource reselection only if the destination user device is the source of the at least one collision indications,
wherein the processor circuit is arranged to perform the resource reselection only if a group leader user device is the source of the at least one collision indications,
wherein the processor circuit is arranged to perform the resource reselection if any user device is the source of the at least one collision indications.

11. The user device of claim 5,
wherein the processor circuit is arranged to perform the resource reselection based on a geographical position or a zone or a speed/change of geographical position of the user device
wherein if the user device is not moving or is moving at a speed below a threshold, the processor circuit is arranged to perform the resource reselection, and/or
wherein if the user device is moving or is moving at a speed above the threshold, the processor circuit is arranged to not to perform the resource reselection, and/or
wherein if the user device is moving out of range of an entity that provided the at least one collision indications, the processor circuit is arranged to not to perform the resource reselection, and/or
wherein if the user device is moving into a geographical area where the at least one collision indications is not valid, the processor circuit is arranged to is not to perform the resource reselection.

12. The user device of claim 5,
wherein the processor circuit is arranged to perform the resource reselection based on a geographical position or a zone of the destination user device
only if a distance between the user device and the provider of the at least one collision indications is below a distance, or if a distance between the user device and the destination user device is below a configured or preconfigured distance, or or if both the provider of the at least one collision indications and destination user device are within the minimum required communication range.

13. The user device of claim 5,
wherein the processor circuit is arranged to perform the resource reselection based on a priority of another transmission on the at least one resources indicated in the at least one collision indications
if a priority of the other transmission is higher than a priority of the at least one transmissions, the processor circuit is arranged to perform the resource reselection and the transmission using reselected resources, and/or
if the priority of the other transmission is lower than the priority of the at least one transmissions, the processor circuit is arranged to not perform the resource reselection and to perform the transmission using the reserved resources.

14. The user device of claim 5,
wherein the processor circuit is arranged to perform the resource reselection based on a measured signal strength of the at least one collision indications,
if a measured signal strength is higher than a configured or pre-configured threshold the processor circuit is arranged to perform the resource reselection and is to perform the transmission using reselected resources
if a measured signal strength is lower than a configured or pre-configured threshold the processor circuit is arranged to not perform the resource reselection and to perform the transmission using the reserved resources
if a measured signal strength is lower than a configured or pre-configured threshold the user device is to not perform the resource reselection and is not to perform the transmission using the reserved resources.

15. The user device of claim 14, wherein the measured signal strength is selected from the group consisting of a signal power, a Signal to Interference and Noise Ratio, an interference power, a Reference Signal Received Power, a Received Signal Strength Indicator, a Rank index, a power in a beam steered towards the user device.

16. The user device of claim 1,
wherein the user device is to repeatedly transmit first information,
wherein the at least one transmissions comprises a plurality of transmissions of the first information on at least one reserved resources,
wherein the at least one collision indications indicates a collision on at least one of the reserved resources used by the user device for the plurality of transmissions,
wherein the processor circuit is arranged to perform a resource reselection for a configured or pre-configured number of transmissions, then the processor circuit is arranged to revert to the reserved resources,
wherein the processor circuit is arranged to perform a resource reselection for a configured or pre-configured time duration, then the processor circuit is arranged to revert to the reserved resources,
wherein the processor circuit is arranged to refrain from a resource reselection and to perform the at least one transmissions in the reserved resources,
wherein the processor circuit is arranged to refrain from a resource reselection and to not perform the at least one transmissions in the reserved resources,
wherein the processor circuit is arranged to perform a change of a priority of the at least one transmissions,
wherein the processor circuit is arranged to perform at least one of the plurality of transmissions on a different carrier, or in a different frequency band, or in a different resource pool or in a different bandwidth part,
wherein the processor circuit is arranged to wait for or trigger of a second user device or a base station to transmit assistance information.

17. The user device of claim 16, wherein the processor circuit is arranged to perform the action bases on
how quickly the first information becomes outdated, or a periodicity indicated in a control message or a priority of the plurality of transmissions, or whether data duplication is enabled in higher layers of the protocol stack, a source of the at least one collision indications, a geographical position or a speed/change of geographical position of the user device or a geographical position of the destination user device.

18. The user device of claim 16, wherein the user device is to transmit the first information periodically.

19. The user device of claim 16,
wherein the processor circuit is arranged to perform, the resource reselection based on how quickly the first information becomes outdated, on the periodicity and on the priority of the plurality of transmissions,
if a frequency with which the first information becomes outdated is below a first threshold, the priority of the transmission is above a second threshold and the periodicity is above a third threshold, or
if a frequency with which the first information becomes outdated is above the first threshold, the priority of the transmission is below the second threshold and the periodicity is below the third threshold, the processor circuit is arranged UE is to perform a resource reselection due to other criteria, or refrain from a resource reselection and transmit in the original selected resources, or refrain from a resource reselection and drop the transmission, or
if a frequency with which the first information becomes outdated is above the first threshold, the priority of the transmission is above the second threshold and the periodicity is below the third threshold, the processor circuit is arranged to perform the resource reselection, or
if a frequency with which the first information becomes outdated is below the first threshold, the priority of the transmission is below the second threshold and the periodicity is above the third threshold, the processor circuit is arranged to perform a resource reselection, or a resource reselection due to other criteria, or refrain from a resource reselection and transmit in the original selected resources.

20. The user device of claim 16,
wherein the processor circuit is arranged to perform the resource reselection based on enablement of data duplication, if data duplication is enabled, the processor circuit is arranged to not to perform the resource reselection for the indicated collision.

21. The user device of claim 16,
wherein the processor circuit is arranged to perform the resource reselection based on a source of the at least one collision indications
wherein the processor circuit is arranged to perform the resource reselection only if the destination user device is the source of the at least one collision indications,
wherein the processor circuit is arranged to perform the resource reselection only if a group leader user device is the source of the at least one collision indications,
wherein the processor circuit is arranged to perform the resource reselection if any user device is the source of the at least one collision indications.

22. The user device of claim 16,
wherein the processor circuit is arranged to perform the resource reselection based on a geographical position or a zone or a speed/change of geographical position of the user device
if the user device not moving or is moving at a speed below a threshold, the processor circuit is arranged to perform the resource reselection, and
if the user device is moving or is moving at a speed above the threshold, the processor circuit is arranged to not to perform the resource reselection,
if the user device is moving into a geographical area where the at least one collision indications is not valid, the processor circuit is arranged to not to perform the resource reselection,

23. The user device of claim 16,
wherein the processor circuit is arranged to perform the resource reselection based on a geographical position or zone of the destination user device,
only if a distance between the user device and the user device providing the at least one collision indications is below a configured or preconfigured distance,
only if a distance between the user device and the destination user device is below a configured or preconfigured distance,
only if both the user device providing the at least one collision indications and destination user device are within the minimum required communication range.

24. The user device of claim 1,
wherein the at least one transmissions comprise a first transmission and at least one second transmissions, and
wherein the processor circuit is arranged to transmit a second transmission on one more future resources, without a resource reselection for the second transmission when the at least one collision indications indicates a collision on at least one resources used by the user device for the first transmission in the past,
wherein the processor circuit is arranged to carry out a second transmission on one more future resources and a resource reselection for the at least one resources indicated in the CI as well as for future reserved resources when the at least one collision indications indicates a collision on at least one resources used by the user device for the first transmission in the past,
wherein the processor circuit is arranged to refrain from second transmission when the at least one collision indications indicates a collision on at least one resources used by the user device for the first transmission in the past,
wherein the processor circuit is arranged to increase a number of second further transmissions configured for the data packet when the at least one collision indications indicates a collision on at least one resources used by the user device for the first transmission in the past,
wherein the processor circuit is arranged to change of a priority of the at least one second transmissions when the at least one collision indications indicates a collision on at least one resources used by the user device for the first transmission in the past,
wherein the processor circuit is arranged to trigger higher layers of the protocol stack to increase or decrease a priority of the at least one second transmissions by the user device when the at least one collision indications indicates a collision on at least one resources used by the user device for the first transmission in the past,
wherein the processor circuit is arranged to transmit a second transmission on a different carrier, or in a different frequency band, or in a different resource pool or in a different bandwidth part when the at least one collision indications indicates a collision on at least one resources used by the user device for the first transmission in the past,
wherein the processor circuit is arranged to wait for or trigger of a second user device or a base station to transmit assistance information, when the at least one collision indications indicates a collision on at least one resources used by the user device for the first transmission in the past,
wherein the processor circuit is arranged to perform data duplication for the at least one second transmissions when the at least one collision indications indicates a collision on at least one resources used by the user device for the first transmission in the past.

25. The user device of claim 1, wherein the processor circuit is arranged to perform the at least one actions when the user device is configured or preconfigured to support at least one certain actions.

26. The user device of claim 1, wherein the processor circuit is arranged to perform the at least one actions based on at least one of a type of the at least one collision indications, a type of a user device providing the at least one collision indications, a priority of the at least one transmissions, a geo-location or a zone of the user device, a number of received collision indications, a cast type, a configuration of a resource pool, a type of a resource pool, a configuration of a bandwidth part, a frequency band in which the user device operates, a Demodulation Reference Signal, a Modulation and Coding Scheme, a type of a destination user device for the transmission by the user device.

27. The user device of claim 26,
wherein the processor circuit is arranged to perform the resource reselection when the configuration or preconfiguration indicates a type of the at least one collision indications
only when receiving the at least one collision indications, indicating at least one potential future collisions, or
only when receiving a at least one collision indications indicating at least one past collisions, or
when receiving a at least one collision indications indicating at least one potential future or past collisions.

28. The user device of claim 26,
wherein the processor circuit is arranged to perform the resource reselection when the configuration or preconfiguration indicates a type of a user device providing the at least one collision indications
only if the at least one collision indications is from the destination user device for the at least one transmissions, or
if the at least one collision indications is received from any user device.

29. The user device of claim 26,
wherein the processor circuit is arranged to perform the resource reselection when the configuration or preconfiguration indicates a priority of the at least one transmissions
only if the at least one collision indications is associated with a transmission that is above a configured or preconfigured priority threshold.

30. The user device of claim 26,
wherein the processor circuit is arranged to perform the resource reselection when the configuration or preconfiguration indicates a geo-location or a zone of the user device
only if a distance between the user device and the user device providing the at least one collision indications is below a configured or preconfigured distance, or
only if a distance between the user device and the destination user device is below a configured or preconfigured distance, or
only if both the user device providing the at least one collision indications and destination user device are within the minimum required communication range.

31. The user device of claim 26,
wherein the processor circuit is arranged to perform the resource reselection when the configuration or preconfiguration indicates a number of received collision indications
only if the number of collision indications associated to a particular resource is above a configured or preconfigured threshold.

32. The user device of claim 26,
wherein the processor circuit is arranged to perform the resource reselection when the configuration or preconfiguration indicates a cast type, only for the indicated cast types.

33. The user device of claim 25, wherein the user device is configured using Radio Resource Control signaling along with a resource pool configuration or a bandwidth part configuration, Media Access Control signaling, or Physical layer signaling.

34. The user device of claim 1,
wherein the user device receives a plurality of collision indications pertaining to different resources the user device reserved for future transmissions,
wherein the processor circuit is arranged to perform at least one of resource reselection for all the indicated resources, triggering a second user device or a base station to transmit assistance information, pausing or drop at least one retransmissions or second transmissions for a time duration or for all transmissions, when the user device is configured or preconfigured with more than one transmit resource pool, change from a current resource pool to a new resource pool, and attempt to transmit the at least one retransmissions or second transmissions in the new resource pool, forward or relay the at least one retransmissions or second transmissions via another user device to the destination user device adapt a power used for the transmission.

35. The user device of claim 34, wherein the processor circuit is arranged to perform the at least one actions if a number of collision indications is higher than an average number of expected collisions in a resource pool.

36. The user device of claim 1,
wherein the user device receives a plurality of collision indications pertaining to resources used by the user device for a first transmission,
wherein the processor circuit is arranged to consider all collision indications and perform a resource reselection for all future resources associated with the first transmission, or
wherein the processor circuit is arranged to use for the first transmission a resource pool that is different from a currently used resource pool if the user device is configured with more than one transmit resource pool.

37. The user device of claim 1,
wherein the processor circuit is arranged to perform the resource reselection based on which of the at least one second transmissions a collision is detected,
wherein the processor circuit is arranged to perform the resource reselection such that the at least one indicated colliding resources are excluded from the reselection procedure.

38. The user device of claim 1,
wherein the processor circuit is arranged to perform the resource reselection for the at least one resources indicated in the at least one collision indications and for at least one future reserved resources up to a pre-configured time duration or number of transmissions,
wherein the processor circuit is arranged to return to an original periodicity after the pre-configured time duration or number of transmissions.

39. The user device of claim 1,
wherein the processor circuit is arranged to use a skipped time slot for sensing in order to detect information about the source of the potential collision or any other interference source when the transmission is skipped, and
wherein the processor circuit is arranged to change, using the information, a future sensing and resource selection procedure when the transmission is skipped.

40. The user device of claim 1,
wherein the processor circuit is arranged to receive the at least one collision indications from the destination user device or from at least one second network entity,
wherein the second network entity is not the destination user device.

41. The user device of claim 1, wherein the at least one resources used by the user device comprise resources used by the user device in the past or resources reserved for use by the user device in the future for the at least one transmissions to the destination user device.

42. The user device of claim 1, wherein the at least one collision indications is selected from the group consisting of an ACK, a NACK, any collision, a past resource collision, a future resource collision or a certain location of a resource collision.

43. The user device of claim 1,
wherein the user device is operated in an out-of-coverage mode,
wherein the user device is not connected to a base station, and/or
wherein the user device is connected to a base station,
wherein the base station is not capable of providing a sidelink resource allocation configuration or assistance for the user device and/or
wherein the user device is connected to a base station of the wireless communication system not supporting a sidelink service.

44. The user device of claim 1, wherein the user device comprise at least one of a power-limited user device or a hand-held user device, or a Pedestrian user device, or an on-body or hand-held user device used by public safety personnel and first responders, or an IoT user device, or a mobile terminal, or a stationary terminal, or a cellular IoT-UE, or a vehicular user device or a vehicular group leader user device or a scheduling user device or an IoT or narrowband IoT device, or a ground based vehicle, or an aerial vehicle, or a drone, or a moving base station, or road side unit, or a building, or any other item or device provided with network connectivity enabling the item/device to communicate using the wireless communication network, or any other item or device provided with network connectivity enabling the item/device to communicate using a sidelink the wireless communication network.

45. (canceled)

46. (canceled)

47. A method comprising:
transmitting and/or receiving over a sidelink,
receiving at least one collision indications
wherein the at least one collision indications indicate at least one collisions on at least one resources,
wherein the at least one resources are used or the at least one resource are arranged for use by the user device for at least one transmissions or for at least one receptions from at least one second user device over the sidelink
performing at least one actions for the at least one transmissions is response to the collision indication and base on at least one criteria.

48. A computer program stored on a non-transitory transitory medium, wherein the computer program when executed on a processor performs the method as claimed in claim 47.
